(19) United States
(12) Patent Application Publication
(10) Pub. No.: US 2026/0171658 A1
(43) Pub. Date: Jun. 18, 2026

(54) RADIO WAVE REFLECTOR, METHOD FOR PRODUCING RADIO WAVE REFLECTOR, RADIO WAVE REFLECTION STRUCTURE, RADIO WAVE REFLECTION SYSTEM, AND RADIO WAVE REFLECTION DEVICE

(71) Applicant: SEKISUI CHEMICAL CO., LTD., Osaka (JP)

(72) Inventors: Yasuaki IDE, Osaka (JP); Danichi MIYAZAKI, Osaka (JP); Hiroyuki NOMOTO, Osaka (JP); Toshio ENAMI, Osaka (JP); Munehiro HATAI, Osaka (JP)

(73) Assignee: SEKISUI CHEMICAL CO., LTD., Osaka (JP)

(21) Appl. No.: 19/127,486

(22) PCT Filed: Nov. 13, 2023
(86) PCT No.: PCT/JP2023/040834

§ 371 Date: May 6, 2025

(30) Foreign Application Priority Data
Nov. 14, 2022 (JP) 2022-181850

(51) Int. Cl. H01Q 1/32; H01Q 15/14; H01Q 17/00

(52) U.S. Cl. CPC H01Q 1/3233; H01Q 15/14; H01Q 17/00

(57) ABSTRACT

Provided are a radio wave reflector capable of reflecting radio waves over a wide area of space, a method for producing a radio wave reflector, a radio wave reflection structure, a radio wave reflection system, and a radio wave reflection device. A radio wave reflector 10 of the present invention is the radio wave reflector 10 with a reflective surface configured to reflect radio waves, a reflective surface 11d having a curved surface that protrudes toward the side where the radio waves are incident or reflected.

### TECHNICAL FIELD

The present invention relates to a radio wave reflector for reflecting radio waves, a method for producing a radio wave reflector, a radio wave reflection structure, a radio wave reflection system, and a radio wave reflection device.

### BACKGROUND ART

In mobile phones and wireless communications, radio waves in the frequency band of 2 GHz or more and 300 GHz or less, called centimeter waves and millimeter waves, are used. Because radio waves with such a short wavelength have a strong tendency to travel in a straight line and are difficult to circumvent even if there are obstacles, reflection plates are installed on the surfaces of buildings, such as walls, floors, ceilings, or pillars (hereafter referred to as “walls or the like”) of buildings, in order to transmit radio waves over a wide area. For example, PTL 1 proposes a communication system in which a monopole antenna and a metal reflection plate that reflects radio waves are installed in the indoor underfloor space. In PTL 1, the reflection plate diffuses the radio waves radiated from the monopole antenna into the underfloor space and prevents the radio waves from leaking out of the underfloor space to the outside of the living room (building) or being absorbed by the floor of the building.

### CITATION LIST

### Patent Literature

PTL 1: Japanese Patent Application Publication No. 2010-258514

### SUMMARY OF INVENTION

### Technical Problem

In general, when a metal reflection plate reflects radio waves, the reflection intensity of the reflected wave is largest at the regular reflection, and the reflection intensity of the reflected wave deviating from the direction of regular reflection is smaller. If a receiver is located in a position that deviates from the direction of regular reflection, the receiver will not be able to receive radio waves of sufficient intensity that would withstand practical use. In particular, if the reflective surface of the metal reflection plate is flat, the reflection intensity of the reflected wave in the regular reflection direction is very high, but the reflection intensity of the reflected wave slightly deviated from the regular reflection direction is very small. Therefore, if a receiver is located in a position slightly deviated from the regular reflection direction, sufficient radio waves may not be able to be obtained in some cases.

The present invention has been completed by focusing on the problem described above and has an object to provide a radio wave reflector capable of reflecting radio waves over a wide area of space, a method for producing a radio wave reflector, and a radio wave reflection system.

### Solution to Problem

In order to achieve the purpose mentioned above, the present encompasses the subject matters described in the invention following Items.
Item 1. A radio wave reflector with a reflective surface configured to reflect radio waves,
   the reflective surface being a curved surface that protrudes toward a side where the radio waves are incident or reflected.
Item 2. The radio wave reflector according to item 1, wherein the reflective surface has a curvature 1/r of 0 (1/m)<1/r≤7.85 (1/m).
Item 3. The radio wave reflector according to item 1, wherein the reflective surface has a curvature 1/r of 5.00 (1/m)<1/r≤7.85 (1/m).
Item 4. The radio wave reflector according to any one of items 1 to 3, including a conductive layer that includes a conductor and constitutes the reflective surface, a base material layer that includes a base material for holding the conductive layer, a protective layer that includes a protective material for protecting the conductive layer, and an adhesive layer that includes an adhesive material for adhering the conductive layer and the protective layer, wherein
   the base material layer, the conductive layer, the adhesive layer, and the protective layer are laminated in this order.
Item 5. The radio wave reflector according to item 4, which has a flexural modulus of 0.05 GPa or more and 4 GPa or less.
Item 6. The radio wave reflector according to any one of items 1 to 5, further including a holding member configured to hold the reflective surface.
Item 7. A method for producing the radio wave reflector as in any one of items 1 to 5, the method including:
   a step of curving the reflective surface so that the reflective surface be a curved surface that protrudes toward a side where radio waves are incident or reflected when attached to an object to be attached.
Item 8. A method for producing the radio wave reflector as in item 6, the method including:
   a step of holding a curved surface that protrudes toward a side where the radio waves of the reflective surface are incident or reflected by the holding member before being attached to an object to be attached.
Item 9. A radio wave reflection structure including:
   the radio wave reflector as in any one of items 1 to 6; and
   an object to be attached to which the radio wave reflector is attached.
Item 10. A radio wave reflection system including:
   a transmitter configured to transmit radio waves;
   the radio wave reflector as in any one of items 1 to 6 configured to reflect the radio waves transmitted from the transmitter;
   a receiver configured to receive the radio waves reflected by the radio wave reflector; and
   a rotary position adjustment device installed in the radio wave reflector and configured to rotate the radio wave reflector.
Item 11. The radio wave reflection system according to item 10, wherein
   the rotary position adjustment device rotates the radio wave reflector around a vertex of a protrusion of the radio wave reflector seen from a plane parallel to a surface including an incident direction and a reflection direction to the reflective surface of radio waves;
   when a rotation angle in a position of the radio wave reflector in a case where radio waves transmitted from the transmitter are regularly reflected toward the receiver is taken as 0 degrees, a clockwise direction of rotation is taken as + direction, and a counterclockwise direction of rotation is taken as − direction,
   a position of the radio wave reflector adjustable by the rotary position adjustment device is within a range of rotation angle of −90 degrees or more and +90 degrees or less.
Item 12. The radio wave reflection system according to item 11, wherein
   the radio wave reflection system has a curvature 1/r of 4.73 (1/m); and
   when the radio wave reflector is located in a position within a range of rotation angle of −83 degrees or more and +83 degrees or less,
   the receiver receives radio waves of −95 dB or more.
Item 13. A radio wave reflection device including:
   the radio wave reflector as in any one of items 1 to 6; and
   a rotary position adjustment device installed in the radio wave reflector and configured to rotate the radio wave reflector.

### Advantageous Effects of Invention

According to the present invention, a radio wave reflector capable of reflecting radio waves over a wide area of space, a method for producing a radio wave reflector, and a radio wave reflection system can be provided.

### BRIEF DESCRIPTION OF DRAWINGS

FIG. 1 is a view for explaining a radio wave reflection system having a radio wave reflector according to one embodiment of the present invention.

FIG. 2 is a view illustrating a schematic configuration of a radio wave reflector, and FIG. 2(A) is a cross-sectional view along the X1-X1 line of FIG. 2(B), and FIG. 2(B) is a perspective view.

FIG. 3(A) is a cross-sectional view of a radio wave reflector of FIG. 3(B), which indicates a schematic configuration of another embodiment of the radio wave reflector, along the X2-X2 line; FIG. 3(B) is a perspective view; and FIG. 3(C) is a perspective view illustrating another embodiment.

FIG. 4 is a cross-sectional view of FIG. 5 along the B-B line when the radio wave reflector is placed on a flat surface without bending.

FIG. 5 is an overall schematic configuration of the radio wave reflector when placed on a flat surface without bending; FIG. 5(A) is a plan view; and FIG. 5(B) is an enlarged view of part A of FIG. 5(A).

FIGS. 6(A) to 6(E) are cross-sectional views illustrating other examples of arrangement patterns of conductors.

FIG. 7(A) is a cross-sectional view illustrating another example of a conductor, and FIG. 7(B) is an enlarged view of part D of FIG. 7(A).

FIG. 8(A) is a cross-sectional view illustrating another example of a conductor, and FIG. 8(B) is an enlarged view of part D of FIG. 8(A).

FIG. 9 is a cross-sectional view illustrating a schematic configuration of a radio wave reflector according to another embodiment when the radio wave reflector is placed on a flat surface without bending the radio wave reflector.

FIG. 10 is a cross-sectional view illustrating a schematic configuration of a radio wave reflector according to another embodiment when the radio wave reflector is placed on a flat surface without bending the radio wave reflector.

FIG. 11(A) is an explanatory view illustrating an application example of a building material to a building, and FIG. 11(B) is a plan view illustrating an example of application to a room.

FIG. 12 is an explanatory view of the rotation angle of the radio wave reflector.

FIG. 13 is a view indicating the measurement result of Comparative Example 1.

FIG. 14 is a view indicating the measurement result of Example 1.

FIG. 15 is a view indicating the measurement result of Example 2.

FIG. 16 is a view indicating the measurement result of Example 3.

FIG. 17 is a view indicating the measurement result of Example 4.

FIG. 18 is an explanatory view of the rotation angle of a receiver.

FIG. 19 is a view indicating the measurement results of Examples 5 to 10 and Comparative Example 2.

FIG. 20 is a view indicating the measurement results of Examples 5 to 10 and Comparative Example 2.

### DESCRIPTION OF EMBODIMENTS

### Overall Configuration

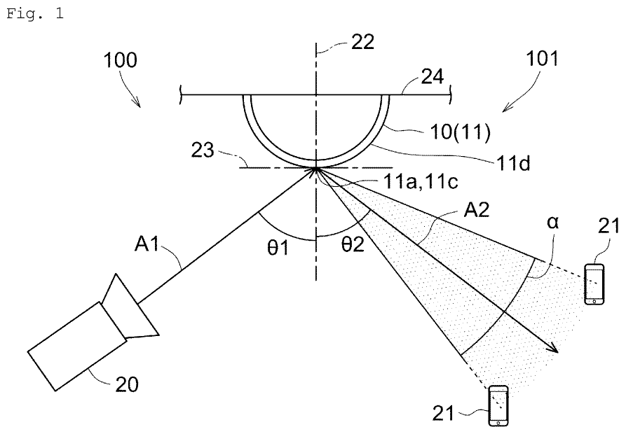

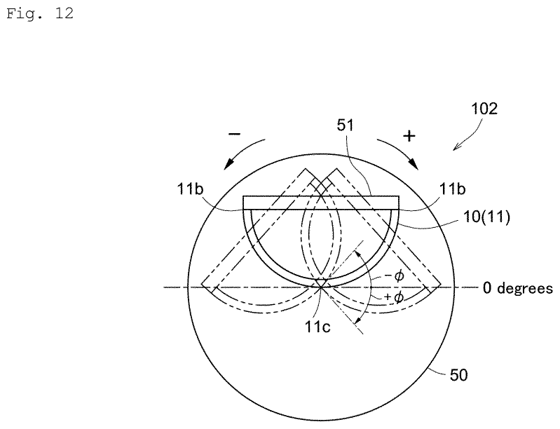

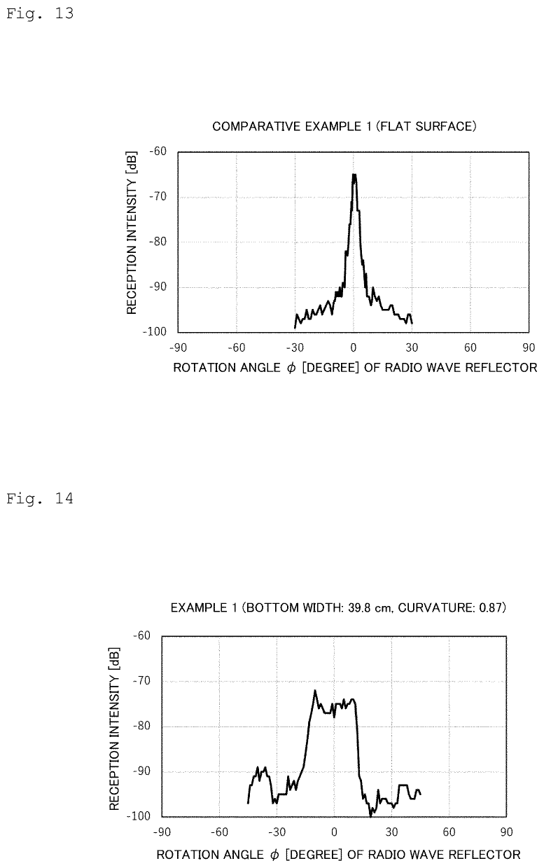

An embodiment of the present invention is explained with reference to the drawings. A radio wave reflection system 100 including a radio wave reflector 10 of the present invention is designed to reflect the radio waves transmitted from a transmitter 20 and propagate the reflected radio waves toward a receiver 21, as illustrated in FIG. 1. The radio wave reflection system 100 includes a transmitter 20 that transmits radio waves; a radio wave reflector 10 that is provided with a reflective surface 11d and reflects the radio waves transmitted from the transmitter 20; and a receiver 21 that receives the radio waves reflected by the radio wave reflector 10. The radio wave reflection system 100 may further include a rotary position adjustment device 50 (FIG. 12) that is installed in the radio wave reflector 10 and rotates the radio wave reflective material 10. The transmitter 20 is, for example, a communication device having a transmission antenna capable of transmitting radio waves. The receiver 21 is a communication apparatus having a receiving antenna capable of receiving radio waves. Examples of the receiver 21 may include a smartphone, a cellular phone, a tablet terminal, a laptop PC, a portable game console, a repeater, a radio, a TV, and the like. The radio wave reflector 10 and an object 24 to be attached to which the radio wave reflector 10 is attached constitute a radio wave reflection structure 101.

Explaining with reference to FIG. 1, regular reflection means that when radio waves emitted from the transmitter 20 are reflected by the radio wave reflector 10, the incident angle θ1 of the incident wave and the reflection angle θ2 of the reflected wave are equal. The incident angle θ1 is an angle between the incident wave traveling in the incident direction (illustrated as an arrow A1 in FIG. 1) when radio waves are incident on the radio wave reflector 10 and a normal 22 of the reflective surface 11d of the radio wave reflector 10, and the reflection angle θ2 is an angle between the reflected wave traveling in the reflecting direction (illustrated as an arrow A2 in FIG. 1) and the normal 22 of the reflective surface 11d. The normal 22 refers to a straight line perpendicularly crossing a tangent line 23 (or tangent plane) at a reflection point 11a of the reflective surface 11d. The intensity of the reflected wave is also referred to as “reflection intensity”. The term “regular reflection intensity” refers to a reflection intensity that is the intensity of the reflected wave when an incident wave is regularly reflected. The term “regular reflection direction” refers to the traveling direction of the reflected wave when the radio wave is regularly reflected. The term “regular reflection angle” refers to the incident angle θ1 of the incident wave and the reflection angle θ2 of the reflected wave upon regular reflection. The frequency of the radio waves transmitted from the transmitter 20 is 2 GHz or more and 300 GHz or less.

The radio wave reflector 10 has the reflective surface 11d that reflects radio waves. The reflective surface 11d is a curved surface that protrudes toward the side where radio waves are incident or reflected, as shown in FIG. 1, in the state when the radio wave reflector 10 is attached to an object 24 to be attached, such as a wall, that is, the so-called attached structure.

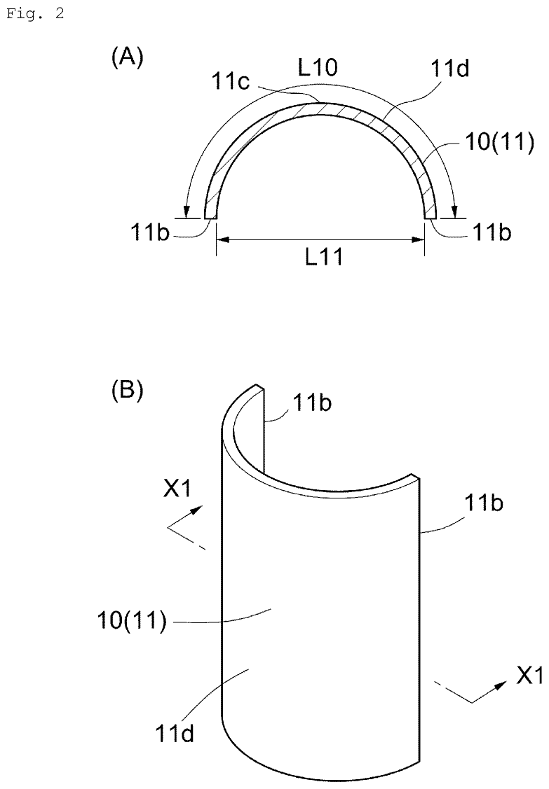

The radio wave reflector 10 may be composed only of the radio wave reflective material 11 or may be constituted of the radio wave reflective material 11 and other members, such as a holding member 40 (described later). In the examples illustrated in FIGS. 2(A) and 2(B), the radio wave reflector 10 is composed only of the radio wave reflective material 11.

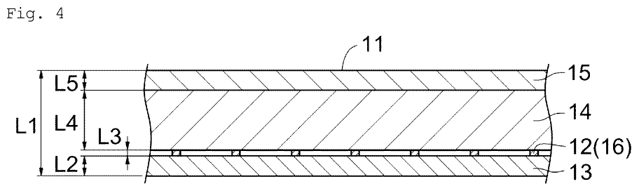

As will be described in detail later, the radio wave reflective material 11 is constituted of a laminate of a conductive layer 16 that includes a conductor 12 and a base material layer 13 that includes base material to hold the conductive layer 16, as illustrated in FIG. 4. The reflective surface 11d refers to a surface on the side where the radio waves are incident or reflected (also referred to as the “outer side”) of the conductive layer 16 that includes the conductor 12 to reflect radio waves in the cross-section along the hypothetical plane including the incident direction of the incident wave from the transmitter 20 and the reflection direction where the reflected wave to be received by the receiver 21 travels. The hypothetical plane including the incident direction of the incident wave from the transmitter 20 and the reflection direction where the reflected wave to be received by the receiver 21 travels is also referred to as a “hypothetical plane including the incident and reflection directions”.

In the present embodiment, the radio wave reflector 10 is curved so as to protrude toward a side where radio waves are incident or reflected in the cross-section along the hypothetical plane including the incident and reflection directions, or seen from a plane parallel to this hypothetical plane. Therefore, the reflective surface 11d included in the radio wave reflective material 11 is also a curved surface that protrudes toward a side where radio waves are incident or reflected. The curvature is set based on this reflective surface 11d.

For example, when the conductive layer 16 is constituted by a thin film-shaped conductor 12 or a conductor 12 that is a metal plate, a reflective surface 11d refers to a surface outside the thin film or the metal plate. For example, when the conductive layer 16 includes a linear conductor 12 and a region 12a with no conductor surrounded by the conductor 12, the reflective surface 11d refers to a surface including the outside surface of the conductor 12 and the region 12a with no conductor.

The radio wave reflective material 11 may be provided with a protective layer 15 that includes a protective material for protecting the conductive layer 16 and an adhesive layer 14 that includes an adhesive material for adhering the conductive layer 16 and the protective layer 15 between the conductive layer 16 and the protective layer 15 on the surface of the conductive layer 16 opposite to the surface on which the base material layer 13 is formed. In other words, the radio wave reflective material 11 may include the base material layer 13, the conductive layer 16, the adhesive layer 14, and the protective layer 15 laminated in this order. The side on which the protective layer 15 is formed (the upper side of FIG. 4) is the side (outer side) where radio waves are incident or reflected. When the thicknesses of the adhesive layer 14 and the protective layer 15 are constant, and the outer surface of the protective layer 15 is parallel to the outer surface of the conductive layer 16, the curvature of the reflective surface 11d is the same as that of the outer surface of the protective layer 15.

It is noted that in FIGS. 1, 2, 3, 12, and 18, the outermost surface of the radio wave reflective material 11 is signed with the reflective surface 11d and a vertex 11c, which will be described later, for illustrative purposes.

The curvature 1/r of the reflective surface 11d of the radio wave reflector 10 is preferably set to 0 (1/m)<1/r≤7.85 (1/m). In the present embodiment, the curvature 1/r of the reflective surface 11d of the radio wave reflector 10 is defined as a reciprocal of the curvature radius r (m) when the curve of the reflective surface 11d of the radio wave reflector 10 is approximated as a circular arc at any point on the reflective surface 11d, which is represented as a curve, in the cross-section along the hypothetical plane including the incident and reflection directions.

The curvature 1/r of the reflective surface 11d is preferably set to 5.00 (1/m)<1/r≤7.85 (1/m) and more preferably set to 5.25 (1/m)<1/r≤7.81 (1/m). The range of this curvature is set on the basis of Examples 9 and 10, in which the angular range was 150 degrees or more in both cases where the frequencies were 4.85 GHz and 28 GHz in Evaluation Test B, which will be described later, and if the curvature of the reflective surface 11d is within this range, radio waves can be reflected over a wide area of space.

When the radio wave reflective material 11 of the radio wave reflector 10 includes the base material layer 13, the conductive layer 16, the adhesive layer 14, and the protective layer 15, and these are laminated in this order, as described above, the flexural modulus of the radio wave reflective material 11 is preferably 0.05 GPa or more and 4 GPa or less. The flexural modulus is a value that indicates how much bending stress a material can withstand, and is defined in JIS K 7171. If the flexural modulus is set to be within the above range, the radio wave reflective material 11 is flexible, and the radio wave reflector 10 can be bent within the above curvature 1/r without breaking the radio wave reflective material 11. The flexural modulus is measured in accordance with JIS K 7171.

The Young's modulus of the radio wave reflective material 11 is preferably 0.01 GPa or more and 80 GPa or less. Young's modulus refers to the elastic modulus when a solid is elongated by applying a tension in a single direction, and is also referred to as tensile elastic modulus. Young's modulus is defined in JIS K 7161-2014. If the Young's modulus is within the above range, the radio wave reflective material 11 tends to be deformable, and the radio wave reflective material 11 can be bent within the above curvature 1/r without breaking the radio wave reflector 10. Young's modulus is measured in accordance with JIS K 7127-1999.

It is sufficient that the radio wave reflector 10 has a reflective surface 11d, which is a curved surface that protrudes toward the side where radio waves are incident or reflected, in a state of being attached to the object 24 to be attached, such as a wall, and any shape may be employed before being attached to the object 24 to be attached. A method for producing the radio wave reflector 10 is as follows, for example. First, the radio wave reflective material 11, which is a sheet-shaped member, is prepared. Then, when the radio wave reflective material 11 is attached to the object 24 to be attached, such as a wall, this radio wave reflective material 11 (sheet-shaped member) is curved so as to protrude toward a side where radio waves are incident or reflected. The radio wave reflector 10 is produced in this way. The radio wave reflector 10 produced is attached to the object 24 to be attached by attaching means, such as an adhesive. In other words, the configuration of the radio wave reflector 10 is the same between before and after being attached to the object 24 to be attached, but the shape is different.

FIGS. 2(A) and 2(B) illustrate an example of the radio wave reflector 10. The radio wave reflector 10 in FIGS. 2(A) and 2(B) is constituted by the radio wave reflective material 11. The radio wave reflective material 11 is a rectangular sheet-shaped member before being attached to the object 24 to be attached. The radio wave reflective material 11 is bent so that opposing side edges 11b approach each other, and this forms the radio wave reflector 10.

As illustrated in FIG. 2(A), the radio wave reflector 10 formed, that is, the radio wave reflector 10 formed only of the radio wave reflective material 11 has a semi-circular cross-sectional shape along the hypothetical plane including the incident and reflection directions, that is, along X1-X1 line illustrated in FIG. 2(B), and protrudes on the side where radio waves are incident or reflected.

The direction orthogonal to the hypothetical plane including the incident and reflection directions is defined as the up-down direction, and the direction on the hypothetical plane including the incident direction and the reflection direction, including the two opposing side edges 11b, is defined as the left-right direction. The radio wave reflector 10 is line symmetrical at the center position in the left-right direction as illustrated in FIG. 2(A). The distance L11 between the opposing side edges 11b (the length between the internal surfaces of two side edges 11b) is also referred to as a “bottom width L11” and is set, as appropriate, according to the size, reflective strength, and the like of the radio wave reflector 10.

A protruding curved surface has the vertex 11c. The vertex 11c of the protrusion is the point that protrudes the most toward the side where radio waves are incident or reflected relative to the base edges of the reflective surface 11d in a cross-section along the hypothetical plane including the incident and reflection directions. In the example of FIG. 2(A), the upper side of FIG. 2(A) is the side where radio waves are incident or reflected, and the vertex 11c is a point that protrudes the most upward from the side edges 11b, which are the base edges. The vertex 11c is the point intersecting the hypothetical line that is orthogonal to the left-right direction and passing the center of the bottom width L11. The vertex 11c extends in the vertical direction, as illustrated in FIG. 2(B).

It is noted that the vertex 11c of the radio wave reflector 10 may be bent so as to extend along the oblique direction with respect to the up-down direction and the left-right direction.

A protruding curved surface means a curved surface with a center protruding toward one side. For example, the protruding curved surface may be any shape along a semi-circular, semi-elliptical, or conical curve in a cross-section along a hypothetical plane including the incident and reflection directions. Alternatively, the entire shape may be semi-spherical or semi-elliptical. A sheet-shaped member is a member in which a length in the longitudinal or transverse direction on one plane in plan view is sufficiently larger than the thickness, and, for example, a member in which the length in the longitudinal or transverse direction is equal to or more than 10 times the thickness.

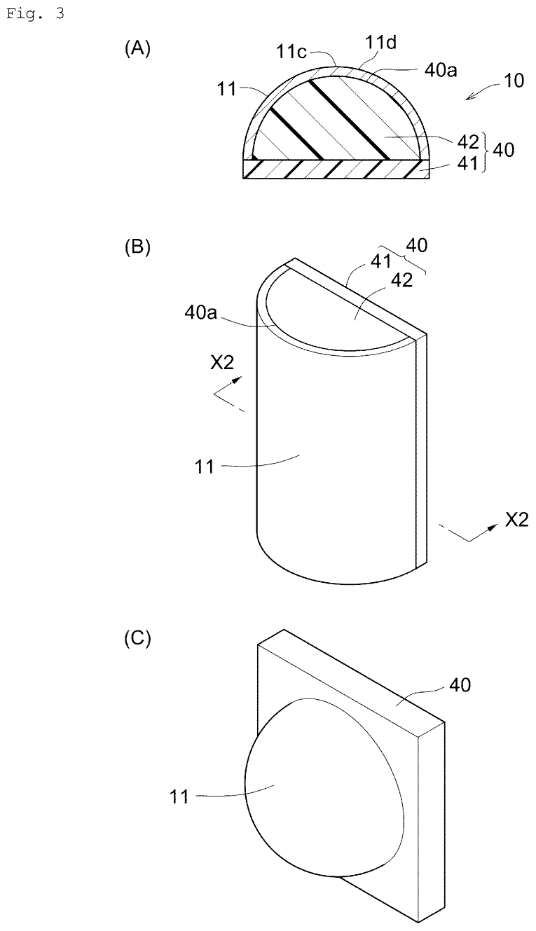

In this example, the radio wave reflective material 11 is a rectangular sheet-shaped member at the time of distribution in the market, that is, before it is attached to a wall or the like, but this sheet-shaped member may be rolled up into a roll. The space created between the radio wave reflector 10, which is in a protruding shape, and the object 24 to be attached, such as a wall, may be filled with a filler material made of resin or the like. Furthermore, a holding member 40 (described later) as illustrated in FIG. 3 may be attached first to the object 24 to be attached, such as a wall, and then the radio wave reflective material 11 may be attached to the protruding outer peripheral surface 40a of the holding member 40.

As illustrated in FIGS. 3(A) and 3(B), the radio wave reflector 10 may include a radio wave reflective material 11 and the holding member 40 that holds the curved surface of a reflective surface 11d of the radio wave reflective material 11. In the example in FIGS. 3(A) and 3(B), the holding member 40 is a base having a protruding outer peripheral surface 40a in cross-section. The protruding shape of the outer peripheral surface 40a of the base corresponds to the curved surface of the reflective surface 11d of the radio wave reflector 11. By attaching the radio wave reflective material 11 on the outer peripheral surface 40a of the base, the radio wave reflector 10, in which the curved surface that protrudes toward the side of the reflective surface 11d where radio waves are incident or reflected, is formed. In one example, the base has a plate-shaped base body 41 with a semi-cylindrical attaching portion 42 on one surface, in which the radio wave reflective material 11 is attached to the outer peripheral surface 40a of the attaching portion 42.

Nevertheless, the base as the holding member 40 is not limited to this, and may be a member having any shape, such as a bent pillar or plate-shaped member, as long as the base has a cross-section with a protruding outer peripheral surface 40a corresponding to the shape of the reflective surface 11d so that the curved surface of the reflective surface 11d of the radio wave reflective material 11 can be held. Furthermore, the holding member 40 does not have to be a base, and, for example, a non-flexible protruding layer may be provided on one surface of the radio wave reflective material 11 as the holding member 40 to hold the curved surface of the reflective surface 11d of the radio wave reflective material 11. At least one of the base material layer 13, the adhesive layer 14, and the protective layer 15 included in the radio wave reflective material 11 may also serve as the holding member 40. In this case, the base material layer 13, adhesive layer 14, and protective layer 15 are formed in a protruding shape and are not flexible, so that the curved surface of the reflective surface 11d is held as the entire radio wave reflector 10.

In the production method of the radio wave reflector 10 illustrated in FIGS. 3(A) and 3(B), the method includes a step of holding the reflective surface 11d of the radio wave reflective material 11 by the holding member 40 before being attached to the object 24 to be attached, that is, holding the curved surface that protrudes toward the side where radio waves are incident or reflected. Then, the radio wave reflector 10, in which the radio wave reflective material 11 and the holding member 40 are integrated, is attached to the object 24 to be attached.

In the example in FIG. 3(B), the radio wave reflective material 11 is attached to the outer peripheral surface 40a of the holding member 40 in a state where the vertex 11c of the protrusion is bent along the up-down direction. However, the embodiment is not limited thereto, and the radio wave reflective material 11 may be attached such that the vertex 11c be along the left-right direction or be along the oblique direction with respect to the up-down direction or left-right direction.

For example, as illustrated in FIG. 3(C), the radio wave reflective material 11 may have a hemispherical shape, or may be a semi-ellipsoid body. In FIG. 3(C), the base of the radio wave reflective material 11 may be attached to the holding member 40.

As illustrated in FIG. 12, the radio wave reflection system 100 of the present embodiment may have a rotary position adjustment device 50 (for example, a rotary stand) for the radio wave reflector 10. The radio wave reflector 10 and the rotary position adjustment device 50 constitute a radio wave reflection device 102. The rotary position adjustment device 50 can rotate the radio wave reflector 10 clockwise and counterclockwise around the vertex 11c when the radio wave reflector 10 is seen from a cross-section along the hypothetical plane including the incident and reflection directions, that is, in plan view illustrated in FIG. 12. As illustrated in FIG. 1, suppose that the radio wave reflector 10 is in a position at a rotation angle φ of 0 degrees when the radio wave reflector 10 regularly reflects radio waves transmitted from the transmitter 20 toward the receiver 21, and a clockwise direction of rotation is taken as + direction, and a counterclockwise direction of rotation is taken as − direction. At this time, the position of the radio wave reflector 10 adjustable by the rotary position adjustment device 50 may be within a range in rotation angle φ of −90 degrees or more and +90 degrees or less in plan view. Specifically, if the curvature 1/r of the reflective surface 11d of the radio wave reflector 10 is 4.73 (1/m), and the radio wave reflector 10 is in a position within the range of rotation angle φ of −83 degrees or more and +83 degrees or less, the receiver 21 can receive radio waves of −95 dB or more.

The applicant found that by providing the radio wave reflector 10 with a curved reflective surface 11d that protrudes toward the side where the radio wave is incident or reflected, the radio wave reflector 10 can reflect radio waves with sufficient intensity that would withstand practical use over a wide area of space, compared to the conventional case where the reflective surface 11d of the radio wave reflector 10 is a flat surface. Therefore, the receiver 21 can receive radio waves with sufficient intensity even when the receiver 21 is in a position where the receiver 21 deviates with respect to the regular reflection direction of radio waves in a hypothetical plane that includes the incident direction of incident radio waves and the reflection direction of reflected waves that are regularly reflected.

If the position of the receiver 21 is determined in advance, the receiver 21 can receive radio waves with an intensity that would withstand practical use by attaching the radio wave reflector 10 in a position where the rotation angle φ is 0 degrees in a hypothetical plane including the incident direction of incident waves and the reflection direction of the reflected waves. However, it is difficult to attach the radio wave reflector 10 in a position where the rotation angle φ is strictly 0 degrees. For example, the object 24 to be attached, such as a wall, that is bent or tilted at an angle may cause the radio wave reflector 10 to deviate from the position where the rotation angle φ is 0 degrees, which may attach the radio wave reflector 10 in a position where the radio wave reflector 10 is rotated in a clockwise or counterclockwise direction from 0 degrees. In such a case, the radio wave is not regularly reflected in the direction of the receiver 21, and radio waves with sufficient intensity do not reach the receiver 21.

However, according to this embodiment, by making the reflective surface 11d of the radio wave reflector 10 a curved surface that protrudes on the side where the radio wave is incident or reflected, the radio wave reflector 10 can reflect radio waves with sufficient intensity that would withstand practical use over a wide area of space. Therefore, even if the radio wave reflector 10 is attached to a rotated position deviating from the position where the reflected wave is regularly reflected toward the receiver 21, the receiver 21 can receive radio waves with an intensity that would withstand practical use.

The radio wave reflector 10 has a total light transmittance of 65% or higher, preferably 80% or higher, more preferably 85% or higher, and still more preferably 90% or higher using the D65 standard light source (one of the standard light sources specified by the International Commission on Illumination (CIE). The total light transmittance refers to the ratio of total transmitted flux to the parallel incident flux of the test specimen and is stipulated in JIS K 7375:2008. The radio wave reflector 10 is so-called “transparent”. The term “transparent” means that the other side of the radio wave reflector 10 is visible when seen from one side and includes semitransparent. The radio wave reflector 10 may be colored as a whole. As will be described in detail later, when the radio wave reflector 10 has the base material layer 13, the adhesive layer 14, and the protective layer 15, each layer may be formed of a resin having a total light transmittance of 65% or more, and the conductor 12 of the conductive layer 16 may be formed to a thickness having a total light transmittance of 65% or more.

In the present embodiment, in the state where the radio wave reflective material 11 (sheet-shaped member) before being bent is placed on a flat surface, as illustrated in FIG. 5(A), the entire shape of the radio wave reflective material 11 (sheet-shaped member) is square in plan view, and the length of one side is preferably 20 cm or longer and 400 cm or shorter. Radio waves with frequencies of 2 GHz or more and 300 GHz or less are attenuated as the distance becomes longer. Nevertheless, it is preferable to set the length of one side L10 to 20 cm or longer in order to reflect radio waves with sufficient intensity at all points within a distance that would withstand practical use from the transmitter 20. The upper limit of the side length L10 is not particularly limited, but the side length L10 is preferably 400 cm or less from the production standpoint. The overall shape is not limited to square, but may be rectangular or polygonal, such as triangular, pentagonal, hexagonal, and the like. In this case, the length of the shortest side is set to 20 cm or longer and 400 cm or shorter. Alternatively, the shortest distance between one vertex and the opposite side thereto or the shortest distance between one side and the opposite side thereto may be set to 20 cm or longer and 400 cm or shorter. If the overall shape of the radio wave reflective material 11 is circular, the diameter thereof is set to 20 cm or longer and 400 cm or shorter. If the overall shape of the radio wave reflective material 11 is an ellipse, the shorter diameter thereof is set to be 20 cm or longer and 400 cm or shorter. If the overall shape of the radio wave reflective material 11 is fan-shaped, the length of the shorter one of the arc or radius is set to be 20 cm or longer and 400 cm or shorter. Furthermore, the overall shape may be a three-dimensional shape, such as a cylinder or a cone.

In order for the receiver 21 to receive radio waves at a sufficient intensity that would withstand practical use, it is necessary to appropriately set the distance between the transmitter 20 and the radio wave reflective material 11 and the distance between the receiver 21 and the radio wave reflective material 11. In addition, the longer the wavelength of radio waves reflected by the radio wave reflective material 11, that is, the smaller the frequency of radio waves, the larger the area of the reflective surface 11d of the radio wave reflective material 11 needs to be. For example, if the frequency is less than 6 GHz and the overall shape of the radio wave reflective material 11 (sheet-shaped material) is a square in plan view, the length of one side is preferably set to 200 cm or shorter.

In the present embodiment, the thickness L1 of the radio wave reflective material 11 is set to about 0.25 mm but is not limited thereto, and the thickness L1 is preferably 1 mm or less. Since the thickness L1 of the radio wave reflective material 11 is small, the conductor 12 has flexibility. The term “flexibility” refers to the property of being flexible under normal temperature and pressure and capable of bending or other deformation without shearing or rupture when force is applied.

The surface resistivity of the radio wave reflective material 11 in a state where the radio wave reflective material 11 is pasted on a wall or the like and made flat is preferably 0.003 Ω/sq. or more and 10 Ω/sq. or less. As will be described in detail later, the surface resistivity is measured as the surface resistivity of the conductor 12. The surface resistivity of the radio wave reflective material 11 in the state where the radio wave reflective material 11 is made flat refers to the surface resistivity of the radio wave reflective material 11 when the radio wave reflective material 11 is placed on a mounting surface that is a flat surface. The term “plane (or flat surface)” refers to a face such that a line connecting any two points on the face is always on the plane.

The term “surface resistivity” means the surface resistance per 1 cm² (square centimeter). The surface resistivity can be measured by the four-terminal method in accordance with JIS K 6911 by bringing a measuring terminal into contact with the surface of the conductive layer 16, which will be described below. If the conductive layer 16 is not exposed because the conductive layer 16 is protected by a resin sheet or the like, the surface resistivity can be measured by the eddy current method using a contactless resistance measuring instrument (product name: EC-80P, manufactured by Napson Corporation, or an equivalent thereof).

The radio wave reflective material 11 may have plasticity. The term “plasticity” refers to the property of being deformable by applying external pressure and retaining the deformed shape even after the force is removed when the deformation exceeds the elastic limit due to applied pressure. All synthetic resins constituting the base material layer 13, the adhesive layer 14, and the protective layer 15 may have plasticity, and at least one of the base material layer 13, the adhesive layer 14, and the protective layer 15 may have plasticity.

### Structure of Radio Wave Reflective Material 11

An example of the structure of the radio wave reflective material 11 is explained with reference to FIGS. 4 and 5. FIGS. 4 and 5(A) are views in a state where the radio wave reflective material 11 (sheet-shaped material) before being bent is placed on a flat surface. The radio wave reflective material 11 may include a conductive layer 16 that includes the conductor 12; the base material layer 13 that includes a base material for holding the conductive layer 16, a protective layer 15 that includes a protective material for protecting the conductive layer 16, and an adhesive layer 14 that includes an adhesive material for adhering the conductive layer 16 and the protective layer 15. In FIG. 4, the radio wave reflective material 11 is laminated in the order of the base material layer 13, the conductive layer 16, the adhesive layer 14, and the protective layer 15 from the bottom.

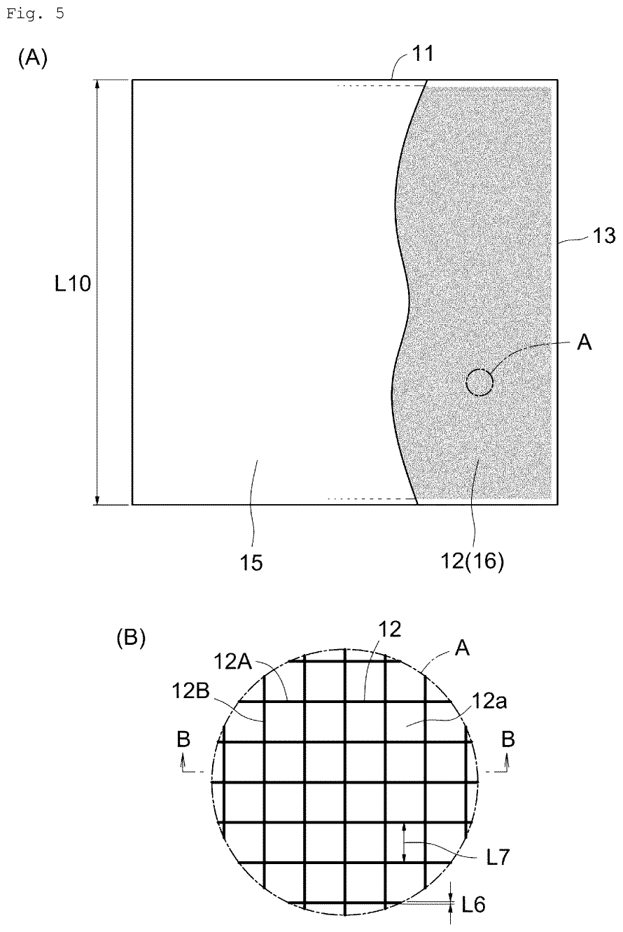

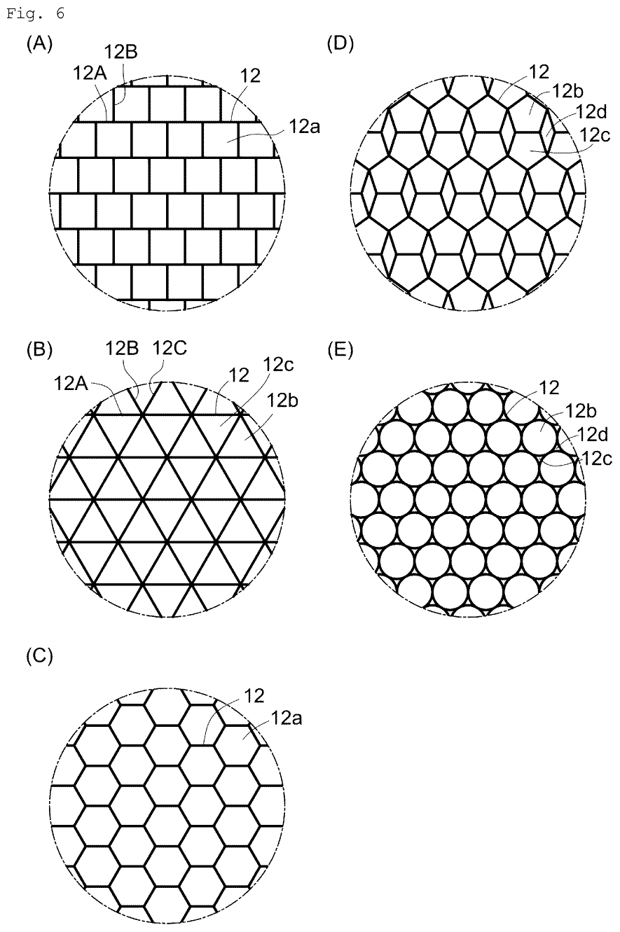

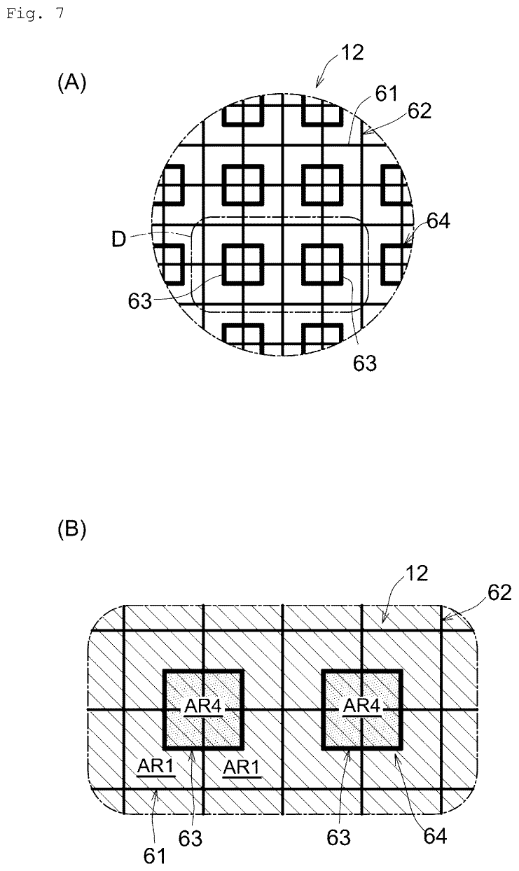

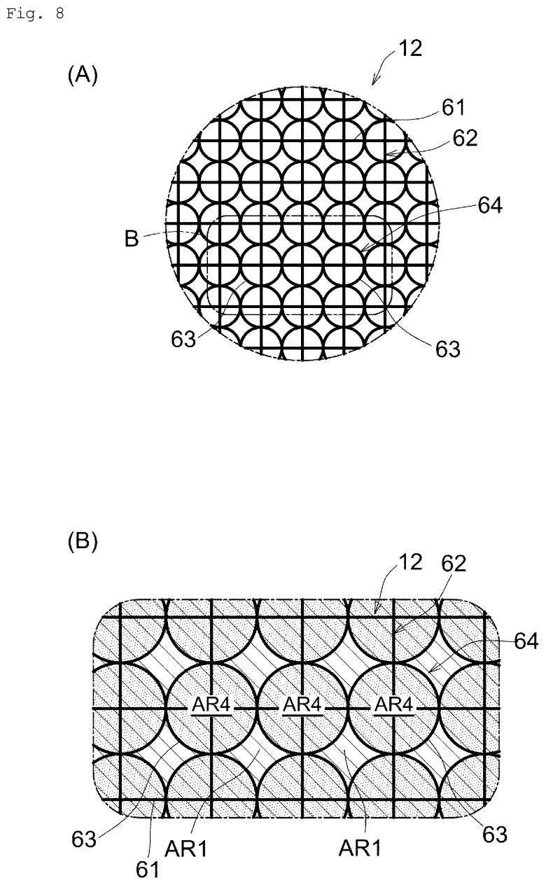

In the description of the structure of the radio wave reflective material 11, the up-down direction is stipulated based on FIG. 4, and the longitudinal-transverse and left-right directions are stipulated based on FIGS. 5 and 6. However, the up-down direction, the longitudinal-transverse direction, and the left-right direction are used for the purpose of explanation only, and the description do not stipulate the up-down direction and the longitudinal-transverse direction during use, such as installation in buildings or the like of the radio wave reflective material 11. In addition, FIGS. 1 to 11 do not show the actual scale. In FIG. 5(A), the adhesive layer 14 and the protective layer 15 are omitted from the illustration of part of the radio wave reflective material 11.

### Base Material Layer 13

The base material layer 13 holds the conductor 12 in an aligned state on the upper surface thereof, and is composed of a base material. In the present embodiment, the external shape is formed into a square shape in plan view, but is not limited thereto. The shape of the base material layer 13 may be a rectangle, circle, ellipse, fan shape, polygon, three-dimensional shape, or the like to match the overall shape of the radio wave reflective material 11. A sheet made of synthetic resin is used as the base material of the base material layer 13. Examples of synthetic resins may include at least one selected from the group consisting of polyethylene terephthalate (PET), polyethylene, polypropylene, polyvinyl chloride, polystyrene, polymethyl methacrylate, polyester, polyformaldehyde, polyamide, polyphenylene ether, vinylidene chloride, polyvinyl acetate, polyvinyl acetal, AS resins, ABS resins, acrylic resins, fluororesins, nylon resins, polyacetal resins, polycarbonate resins, polyamide resins, and polyurethane resins. The thickness L2 (the length in the up-down direction in FIG. 4) of the base material layer 13 is set to 50 μm in the present embodiment, but is not limited thereto. The base material layer 13 may include any substance, such as any synthetic resin, or any material in addition to the base material.

### Conductive Layer 16

The conductive layer 16 preferably has one or a plurality of linear conductors 12 formed as a thin film on the upper surface of the base material layer 13. The conductor 12 is preferably composed of silver (Ag), for example. The conductor 12 is not limited to silver, as long as it is composed of a metal having free electrons, and may be, for example, gold, copper, platinum, aluminum, titanium, silicon, indium tin oxide, and alloys (for example, alloys containing nickel, chromium, and molybdenum). Examples of alloys containing nickel, chromium and molybdenum may include various grades of Hastelloy B-2, B-3, C-4, C-2000, C-22, C-276, G-30, N, W, X, and the like.

The thickness (film thickness) L3 of the conductive layer 16 (conductor 12) is set to 500 nm (0.5 μm) in the present embodiment but is not limited thereto. The thickness L3 is preferably 5 nm or more from the viewpoint of ensuring appropriate radio wave intensity. The conductive layer 16 may include any substance, such as any synthetic resin, or any material, in addition to the conductor 12.

The conductive layer 16 preferably has a surface resistivity of 3.5 Ω/sq. or less. The surface resistivity of the conductive layer 16 is, in other words, the surface resistivity of the radio wave reflective material 11.

In one example, the conductive layer 16 has one or a plurality of linear conductors 12 arranged to surround a region 12a with no conductor 12. In other words, the conductors 12 and the region 12a with no conductor 12 surrounded by the conductors 2 are periodically arranged at regular intervals. The distance between adjacent regions 12a with no conductor 12 may be equal to a line width L6 of the conductor 12, or may be longer than the line width L6. The term “linear” means that the length in the longitudinal direction is at least 3000 times longer than the length in the direction perpendicular to the longitudinal direction. The arrangement pattern of the conductor 12 of the present embodiment is such that the conductors 12 are arranged at equal intervals in the longitudinal and transverse directions, as shown in FIG. 5(B), and the region 12a with no conductor 12, surrounded by the conductors 12, is a square. In other words, the region 12a with no conductor 12 is arranged with intervals of the line width L6 of the conductors 12. The conductors 12A and 12B are electrically conductive at the intersection where the conductor 12 (12A) along the transverse direction and the conductor 12 (12B) along the longitudinal direction overlap each other. The line width L6 of the conductors 12 is set to 0.1 μm or more and 4.0 μm or less. A length L7 (the length of one side of the square region 12a with no conductor 12) between adjacent conductors 12 in the longitudinal or transverse direction is set to be greater than the wavelength of visible light and less than the wavelength of radio waves reflected by the radio wave reflective material 11. In this embodiment, the length L7 is set to 2 μm or more and 10 cm or less. The length L7 is more preferably 20 μm or more and 1 cm or less, and still more preferably 25 μm or more and 1 mm or less. The length L7 is further more preferably 30 μm or more and 250 μm or less.

The arrangement pattern of the conductors 12 is not limited to the arrangement illustrated in FIG. 5(B). For example, the interval between adjacent conductors 12A extending in the transverse direction and the interval between adjacent conductors 12B extending in the longitudinal direction may differ, and the shape of the region 12a with no conductor 12 may be rectangular.

The conductors 12 may be arranged in the arrangement pattern illustrated in FIGS. 6(A) to 6(E). In FIG. 6(A), the arrangement of the conductors 12 is in a brickwork pattern. A plurality of first linear bodies 12A are arranged along the transverse direction and in the vertical direction at predetermined intervals, and a plurality of second linear bodies 12B extending in the longitudinal direction are arranged in a staggered pattern between the first linear bodies 12A adjacent in the longitudinal direction. The term “staggered” refers to a state where a plurality of longitudinally extending second linear bodies 12B are arranged with specific intervals in the transverse direction, such that a plurality of second linear bodies 12B forming one row are located between a plurality of second linear bodies 12B forming the longitudinally adjacent row of this row, and the second linear bodies 12B in a row second adjacent thereto are aligned in a straight line. The region 12a with no conductor 12 is a region surrounded by the two adjacent first linear bodies 12A and the two adjacent second linear bodies 12B.

In FIG. 6(B), the conductor 12 is arranged such that the region 12a with no conductor 12 is a triangular shape. As the region 12a with no conductor 12, a plurality of triangular-shaped first regions 12b and a plurality of inverted triangular-shaped second regions 12c are provided. The first regions 12b and the second regions 12c are arranged at regular intervals in the longitudinal and transverse directions, respectively, and the second regions 12c are arranged between adjacent first regions 12b. Each of the first region 12b and the second region 12c is surrounded by the first to third linear bodies 12A to 12C. The first linear body 12A is arranged along the transverse direction, the second linear body 12B is arranged along a direction inclined at an angle to the first linear body 12A, and the third linear body 12C are arranged along a direction symmetrical to the second linear body 12B with respect to the first linear body 12A.

In FIG. 6(B), each of the regions 12b and 12c is an equilateral triangle, but may be an isosceles triangle or a triangle with three sides of different lengths.

In FIG. 6(C), the conductor 12 is arranged surrounding a regular hexagon-shaped region 12a with no conductor 12. The region 12a with no conductor 12 is arranged in continuous rows with intervals of the line width L6 of conductor 12 in the longitudinal direction, and this row is arranged in a plurality of rows in the transverse direction. Between the regions 12a with no conductor 12 that are adjacent to each other in the longitudinal direction, the regions 12a with no conductor 12 that are adjacent in the transverse direction are arranged.

In FIG. 6(D), as the region 12a with no conductor 12, several differently shaped regions 12b to 12d are arranged. The region 12a with no conductor 12 includes the first region 12b with a regular pentagonal shape surrounded by linear conductors 12, the second region 12c with an inverted regular pentagonal shape, and the third region 12d with a diamond shape. The first region 12b to the third 12d region are arranged at regular intervals in the transverse and longitudinal directions, respectively. In detail, the first region 12b and the second region 12c are arranged next to each other in the longitudinal direction with intervals of the line width L6 of the conductor 12, and these pairs of the first region 12b and the second region 12c are arranged side by side in the transverse direction in a periodic manner. The third region 12d is arranged between the pair of first region 12b and second region 12c, which are adjacent to each other in the transverse direction. The shapes formed by the first region 12b, the second region 12c, and the third region 12d are arranged in the same period.

In FIG. 6(E), as the region 12a with no conductor 12, several differently shaped regions 12b to 12d with no conductor 12 are arranged. The region 12a with no conductor 12 includes the first region 12b with a circular shape surrounded by linear conductor 12, the second region 12c with a substantially triangular shape, and the third region 12d with a substantially inverted triangular shape. The first region 12b to the third region 12d are arranged at regular intervals in the longitudinal and transverse directions, respectively, in a periodic manner. The first region 12b is periodically arranged in a transverse and diagonal alignment so that the first region 12b be continuous with intervals of line width L6 of the conductor 12.

Note that FIGS. 6(A) to 6(E) illustrate only the conductor 12. The configuration of the conductor 12 other than the arrangement pattern, for example, the thickness L3, line width L6, and metal type of the conductor 12, may be set as in FIG. 5(B).

The conductive layer 16 preferably has a conductor coverage ratio of 1% or more and 10% or less. The conductor coverage ratio refers to the percentage of area occupied by the conductor 12 per unit area in plan view. The coverage ratio can also be said to be the ratio of the area of the base material layer 13 covered by the conductor 12 to the area of the base material layer 13 in plan view. When the conductive layer 16 is not provided on the periphery of the base material layer 13 but is provided inside the edge of the base material layer 13, as in the embodiments illustrated in FIGS. 4 and 5, the coverage ratio is a ratio of the area occupied by the conductor 12 per unit area in the region where the conductive layer 16 is provided on the upper surface of the base material layer 13 in plan view. The region where the conductive layer 16 is provided is the region of the upper surface region of the base material layer 13 excluding the periphery of the base material layer 13 (the region between the edges of the base material layer 13 and the conductive layer 16). The conductor coverage ratio is measured using a scanning electron microscope (SEM), transmission electron microscope (TEM), optical microscope, or the like.

As the method for producing the conductive layer 16 with the arrangement pattern described above, a method of shaping a conductor film, then forming a pattern by etching, and taking out the patterned conductive thin film may be mentioned. Another method includes coating a photosensitive resist on a base film with a lift-off layer, forming a pattern by photolithography, filling the patterned portion with a conductive material, and then removing the patterned conductive thin film body.

### Other Embodiments of Conductive Layer 16)

The conductor 12 constituting the conductive layer 16 may be, for example, a mode as illustrated in FIG. 7. The conductor 12 has a first conductive section 62 including a plurality of first enclosures 61 and a second conductive section 64 including a plurality of second enclosures 63 formed in an overlapping pattern. The first enclosure 61 and the second enclosure 63 do not share any portions when projected onto a projection plane parallel to the conductive layer 16.

In the first conductive section 62, the first enclosure 61 surrounding a first region AR1 where the conductor 12 is not formed is repeatedly formed at a regular pitch. In this case, the first conductive section 62 is formed in a grid pattern, but the first conductive section 62 may also be formed in pentagonal, hexagonal, circular, or other shapes.

The second conductive section 64 surrounds a fourth region AR4, the region where the conductor 12 is not formed. The fourth region AR4 is formed over a plurality of adjacent first regions AR1. The second conductive section 64 may be located on the same plane as the first conductive section 62 or on different planes. In other words, the second conductive section 64 may or may not be conductive to the first conductive section 62. The adjacent second conductive sections 64 are separated from each other, but may be in contact. The second conductive sections 64 are formed in a square shape, but may also be in pentagonal, hexagonal, circular, or other shapes.

The conductor 12 may be, for example, a mode as illustrated in FIG. 8. The mode of FIG. 8 differs from the mode of FIG. 7 in the shape of the second conductive section 64 (second enclosure 63), where the second enclosure 63 is circular in shape. The center point of the second enclosure 63 is positioned to overlap the intersection of the first conductive section 62 formed in a grid pattern, and the diameter of the second enclosure 63 is equal to the grid pitch of the first conductive section 62. That is, adjacent second enclosures 63 are in contact with each other. The adjacent second enclosures 63 may be separated from each other. Since the other configurations are the same as those in the mode in FIG. 6, corresponding configurations are signed with the same numerals and omitted from the explanation.

### Adhesive Layer 14

The adhesive layer 14 adheres the protective layer 15 on the base material layer 13 and the conductive layer 16 and is constituted of an adhesive material. The adhesive layer 14 has a size corresponding to the base material layer 13 in plan view. As the adhesive material for the adhesive layer 14, an adhesive sheet made of synthetic resin or rubber is used. Examples of synthetic resins may include an acrylic resin, a silicone resin, a polyvinyl alcohol resin, and the like. The thickness L4 of the adhesive layer 14 is set to 150 μm in the present embodiment, but the thickness L4 is not limited to this value. The adhesive layer 14 may include any substance, such as any synthetic resin, or any material, in addition to the adhesive.

The adhesive layer 14 is preferably made of a synthetic resin material with a dielectric loss tangent (tan δ) of 0.018 or less. The lower the dielectric loss tangent, the more preferable, but the dielectric loss tangent is usually 0.0001 or more. The dielectric loss tangent represents the degree of electric energy loss in a dielectric, and the larger the dielectric loss tangent of the material, the greater the electrical energy loss. By using an adhesive layer 14 with a dielectric loss tangent of 0.018 or less, the electric energy loss of radio waves in the radio wave reflective material 11 is reduced, and the reflective intensity can be made stronger.

It is preferable that the synthetic resin material of the adhesive layer 14 has a relative permittivity that varies with the frequency of the electric field. The relative permittivity is a ratio of the dielectric constant of the medium (the synthetic resin material in the present embodiment) to that of the vacuum. The change in relative permittivity in response to an electric field can increase the intensity of reflected waves in an electric field of a specific frequency. It is preferable that the relative permittivity varies in the range of 1.5 or more and 7 or less. It is more preferable that the relative permittivity varies in the range of 1.8 or more and 6.5 or less. The dielectric loss tangent and relative permittivity are measured by known methods (for example, cavity resonator method or coaxial resonator method) using a measurement device (for example, material impedance analyzer MIA-5M, model number TTPX tabletop cryogenic prober, manufactured by Toyo Corporation).

The synthetic resin material constituting the adhesive layer 14 as well as the base material layer 13 and the protective layer 15 may have a dielectric loss tangent of 0.018 or less, and the relative permittivity may change in response to an electric field.

The hydroxyl value of the adhesive layer 14 is preferably 5 mgKOH/g or more, more preferably 8 mgKOH/g or more, further preferably 30 mgKOH/g or more, and still more preferably 90 mgKOH/g or more. Meanwhile, the upper limit of the hydroxyl value of the adhesive layer 14 is preferably 120 mgKOH/g or less. When the hydroxyl value of the adhesive layer 14 is 5 mgKOH/g or more, the adhesive layer 14 has the advantage of being less likely to foam and/or whiten under high temperature and high humidity environments. In the description, the hydroxyl value is measured by a method in accordance with JIS K 1557.

The acid value of the adhesive layer 14 is preferably 50 mgKOH/g or less, more preferably 45 mgKOH/g or less, still more preferably 30 mgKOH/g or less, and further preferably 10 mgKOH/g or less. Meanwhile, the lower limit of the acid value of the adhesive layer 14 is preferably 0.1 mgKOH/g or more. When the acid value of the adhesive layer 14 is 50 mgKOH/g or less, the conductor 12 can be prevented from corroding, and the stability of radio wave reflectivity over time can be increased. In the description, the acid value is measured by a test method in accordance with JIS K 2501.

It is preferable that the adhesive layer 14 is free of a UV absorber. When the adhesive layer 14 is free of a UV absorber, there is an advantage that the adhesive layer 14 can be easily adjusted to be colorless and transparent. Here, the term “free of” includes a case where the adhesive layer 14 is completely free of a UV absorber, but also a case where the adhesive layer 14 contains only a slight amount that does not impair colorlessness and transparency.

### Protective Layer 15

The protective layer 15 has a size corresponding to the base material layer 13 in plan view, protects the conductor 12, and is composed of a protective material. A film made of synthetic resin is used as the protective material of the protective layer 15. Examples of synthetic resins may include at least one selected from the group consisting of polyethylene terephthalate (PET), cycloolefin polymer (COP), polyethylene, polypropylene, polyvinyl chloride, polystyrene, polymethyl methacrylate, polyester, polyformaldehyde, polyamide, polyphenylene ether, vinylidene chloride, polyvinyl acetate, polyvinyl acetal, AS resins, ABS resins, acrylic resins, fluororesins, nylon resins, polyacetal resins, polycarbonate resins, polyamide resins, and polyurethane resins. The thickness L5 of the protective layer 15 is set to 50 μm in the present embodiment, but it is not limited to this value. The protective layer 15 may include any substance, such as any synthetic resin, or any material, in addition to the protective material.

The protective layer 15 may have an anti-glare or anti-reflection treatment applied to at least one of the upper surface (outer surface) and lower surface (surface in contact with the adhesive layer 14) in FIG. 4 of the film made of synthetic resin, for example.

The anti-glare treatment (also referred to as “AG treatment” or “non-glare treatment”) is a treatment that forms an uneven surface on at least one surface of the protective layer 15 to scatter light and reduce the reflection of light sources such as lighting on the protective layer 15. As a method for applying anti-glare treatment, a method of applying a binder resin containing dispersed fine particles to the surface of a film may be mentioned, for example. Known methods such as sandblasting, chemical etching, or the like may be used.

The anti-reflection treatment (also called “AR treatment”) is a treatment that forms an anti-reflection coating on at least one surface of the film and attenuates the reflection of light from the anti-reflection coating surface and the reflection of light from the interface between the anti-reflection coating and the film by interference, thereby suppressing the reflection of light sources such as lighting. The anti-reflection coating may have a single-layer structure, and may be a structure in which thin films with different refractive indices are alternately laminated, and known anti-reflection coatings are used.

The protective layer 15 may have a film that has been subjected to an anti-glare treatment or anti-reflection treatment attached to one or both surfaces of a synthetic resin film.

The moisture permeability of the protective layer 15 at a temperature of 40° C. and a humidity of 90% rh (relative humidity) is preferably 20 g/mm²·24 h or less, more preferably 16 g/m²·24 h or less, still more preferably 12 g/m²·24 h or less, and further preferably 10 g/m²·24 h or less. When moisture permeability of the protective layer 15 at a temperature of 40° C. and a humidity of 90% rh (relative humidity) is 20 g/m²·24 h or less, there are advantages that the conductive layer 16 is less likely to corrode and the surface resistivity of the conductive layer 16 is less likely to increase. The “moisture permeability” used in the present description is measured by a test method in accordance with JIS Z 0208 (1976).

### Other Embodiments of Configuration of Radio Wave Reflective Material 11

FIG. 9 shows another embodiment of the present invention. FIG. 9 is a view in a state where the radio wave reflective material 11 (sheet-shaped material) before being bent is placed on a flat surface. The radio wave reflective material 11 illustrated in FIG. 9 has two layers of conductive layers 16A and 16B laminated in the up-down direction. The conductive layer 16A formed on the base material layer 13A is aligned with the conductive layer 16B formed on the base material layer 13B so that the arrangement patterns overlap when viewed from the plane. The arrangement patterns of the conductive layers 16A and 16B may not be overlapped in a plan view, and the conductive layers 16A and 16B may be formed by different arrangement patterns. The lower surface of the base material layer 13B is stuck onto the conductive layer 16A with an adhesive layer 14A, and the protective layer 15 is stuck onto the conductive layer 16B with an adhesive layer 14B.

The ratio waves incident on the radio wave reflective material 11 is reflected on the conductive layer 16B of the first layer, but part of the radio waves is not reflected on the conductive layer 16B and passes through the conductive layer 16B. The radio waves passed through this conductive layer 16B are reflected on the conductive layer 16A of the second layer. As such, by laminating a plurality of conductive layers 16 that include the conductor 12 in the up-down direction, radio waves passed through the conductive layer 16B of the upper layer can be reflected on the conductive layer 16A of the lower layer, and the reflection intensity of the radio wave reflective material 11 can be retained greater than that of the case where the conductor 12 is only one layer. Furthermore, since double-layered adhesive layers 14A and 14B are used, the value of the dielectric loss tangent is further smaller than that of the embodiment indicated in FIG. 4, and the reflection intensity can be maintained to an even greater degree. Other configurations and actions are the same as those illustrated in FIGS. 4 and 5. Thus, detailed explanations are omitted by assigning the same numerals to the corresponding configurations.

In the embodiment in FIG. 9, two conductive layers 16 formed on the base material layer 13 are laminated, but three or more conductive layers 16 may be laminated. The larger the number of conductive layers 16 laminated, the greater the reflection intensity, but the thicker the entire thickness of the radio wave reflective material 11, which decreases total light transmittance and flexibility. Therefore, the number of layers of conductive layers 16 is set, as appropriate, according to the intended use and so on.

### Other Embodiments of Configuration of Radio Wave Reflective Material 11)

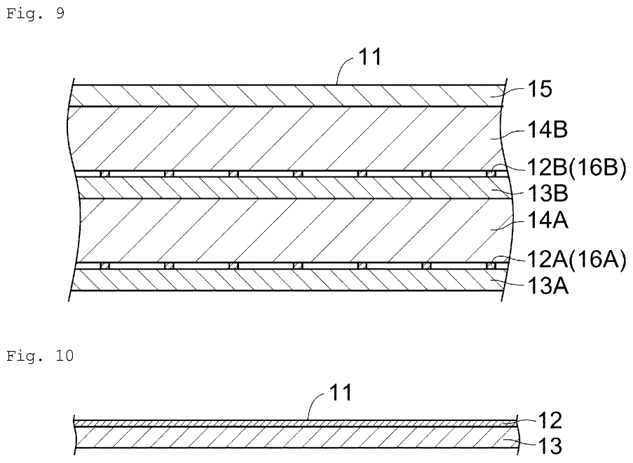

FIG. 10 shows another embodiment of the radio wave reflective material 11. FIG. 10 is a view in a state where the radio wave reflective material 11 (sheet-shaped material) before being bent is placed on a flat surface. In the embodiment in FIG. 10, the radio wave reflective material 11 includes the conductive layer 16 and the base material layer 13 but does not include the adhesive layer 14 and the protective layer 15. In this case, the conductor 12 of the conductive layer 16 is formed in a square shape on substantially the whole surface of the upper surface of the base material layer 13 as a sheet-shaped thin film. The thickness L3 of the conductor 12 is 10 nm in the present embodiment but is not limited thereto. In the present embodiment, the surface resistivity is 9.8 Ω/sq. In the embodiment in FIG. 10, the conductor coverage ratio is stipulated as a ratio of the area occupied by the conductor 12 per unit area in the part on the base material layer 13 where the conductive layer 16 is formed, and the conductor coverage ratio is 100%. In the present embodiment, the total light transmittance of the radio wave reflective material 11 is 70%. Other configurations and actions are the same as those illustrated in FIGS. 4 and 5. Thus, detailed explanations are omitted by assigning the same numerals to the corresponding configurations.

In the present embodiment, the conductive layer 16 is composed of one sheet of the conductor 12, but may be composed of plural sheets of the conductor 12. In this case, a plurality of the conductors 12 are arranged at specific intervals over substantially the entire upper surface of the base material layer 13. The shape of the conductor 12 may be circular, rectangular, triangular, polygonal, or the like.

### (Usage)

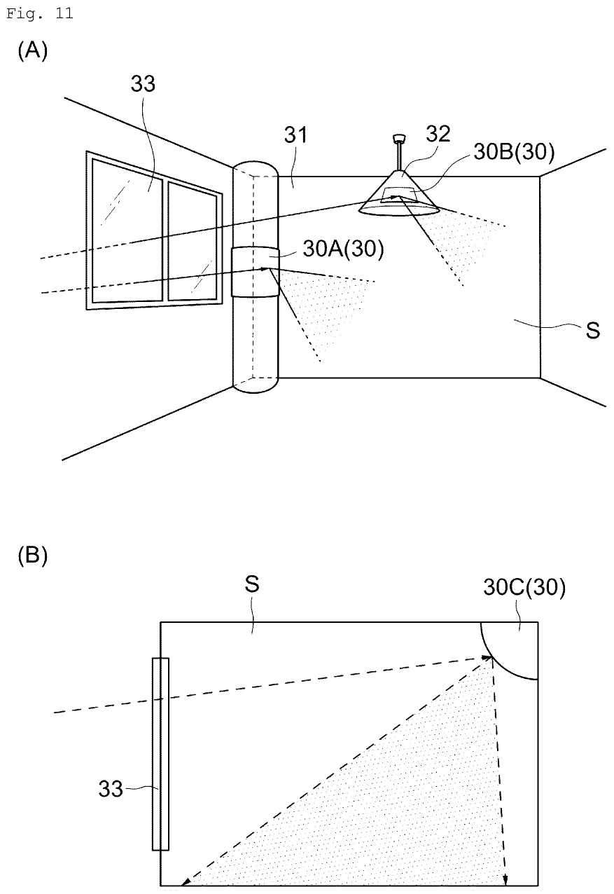

The radio wave reflector 10, which includes one of the above-mentioned radio wave reflective materials 11, may be included in and used as a building material 30. The building material 30 can be attached to the interior of a building as a decorative material 30A, such as wallpaper or posters for walls, ceiling surfaces, floors, and partitions in rooms and hallways, or as a decorative material 30B, such as transparent stickers for light covers, as illustrated in FIG. 11(A). For example, by attaching decorative materials 30A and 30B, which include the radio wave reflectors 10, to a wall surface 31 and a light cover 32, radio waves that enter the room from outside via windows 33, or the like are reflected by the decorative materials 30A and 30B attached to the wall surface 31 and the light cover 32. This allows radio waves to reach a wider area of the interior space S, improving the convenience of radio reception.

The radio wave reflector 10 may be formed as being held inside the building material 30. For example, the wall surface 31 itself or the light cover 32 itself, which are building materials 30, may be composed of the radio wave reflector 10. Furthermore, the building material 30 is not limited to interior walls and light covers, but may be partitions, pillars, lintels, building exterior walls, windows, or the like. For example, FIG. 11(B) is a plan view of a room, where the building material 30 that is the radio wave reflector 10 is formed as a corner pillar 30C with curved surfaces at the corners of the room. The radio waves entering the window 33 are reflected on the corner pillar 30C, whereby the radio waves reach a wider area in the interior space S. It is noted that FIGS. 11(A) and 11(B) indicate application examples of the building material 30 and do not indicate the actual range of reflection of radio waves. The radio wave reflector 10 may be held not only in the building material 30 but also in a member made of non-conductive material such as resins and may be used in any place.

### Evaluation Test

Examples 1 to 10 and Comparative Examples 1 and 2 were prepared as radio wave reflectors 10, and evaluation tests were conducted on the reception intensity of the receiver 21 in these Examples 1 to 10 and Comparative Examples 1 and 2. However, the radio wave reflector 10 is not limited to Examples 1 to 10.

### Evaluation Test A

### Examples 1 to 4 and Comparative Example 1

As shown in FIG. 5(A), the radio wave reflectors 10 in Examples 1 to 4 are sheet-shaped members that are in square shapes in plan view with a side length L10 of 40 cm and a thickness L1 of 0.25 mm in a state before being attached to the object 24 to be attached. This sheet-shaped material is formed into the shape illustrated in FIGS. 2(A) and 2(B) by bending the above sheet-shaped material so that the side edges 11b in the up-down direction of the radio wave reflective material 11 (sheet-shaped material) approach each other and the protruding vertex 11c is positioned at the center of the left-right direction. In other words, as shown in FIG. 2(A), the cross-sectional shape of the radio wave reflector 10 is semicircular along a hypothetical plane including the incident and reflection directions, and is a shape that protrudes toward the side where the radio waves are incident or reflected.

The bottom widths L11 and the curvatures of the reflective surfaces 11d of Examples 1 to 4 are as follows:

### (1) Example 1

Bottom width L11 (cm): 39.8
Curvature 1/r (1/m): 0.87

### (2) Example 2

Bottom width L11 (cm): 35.0
Curvature 1/r (1/m): 2.21

### (3) Example 3

Bottom width L11 (cm): 30.0
Curvature 1/r (1/m): 3.19

### (4) Example 4

Bottom width L11 (cm): 20.0
Curvature 1/r (1/m): 4.73

Comparative Example 1 is a sheet-shaped member having a square planar shape with a side length L10 of 40 cm and a thickness L1 of 0.25 mm. The reflective surface 11d is not a protruding reflective surface and is a flat surface. In other words, it is said that the sheet-shaped member is a sheet-shaped member illustrated in FIG. 5(A), which is a radio wave reflector 10 before being bent.

Other configurations of Examples 1 to 4 and Comparative Example 1 are as follows. Since Examples 1 to 4 and Comparative Example 1 have the same configuration unless otherwise specified, only an explanation of Example 1 is made in the following explanation, and explanations of Examples 2 to 4 and Comparative Example 1 are omitted.

The radio wave reflective material 11, which was produced as a radio wave reflector 10 as Example 1, includes a conductive layer 16, a base material layer 13, a protective layer 15, and an adhesive layer 14 that includes an adhesive material for adhering the conductive layer 16 and the protective layer 15, which are laminated in the order of the base material layer 13, the conductive layer 16, the adhesive layer 14, and the protective layer 15 from the bottom. The thickness L1 of the radio wave reflective material 11 is the total of the thickness L3 of the conductive layer 16, the thickness L2 of the base material layer 13, the thickness L4 of the adhesive layer 14, and the thickness L5 of the protective layer 15. However, since the thickness L3 of the conductive layer 16 is much thinner than each of the thicknesses L2, L4, and L5 of the base material layer 13, adhesive layer 14, and protective layer 15, the thickness L3 of the conductive layer 16 is not taken into account in the thickness L1 of the radio wave reflective material 11.

A synthetic resin material sheet (Lumirror 50T60, manufactured by Toray Industries, Inc.) made of PET was used as the base material layer 13, and the thickness L2 of the base material layer 13 was 50 μm.

The conductor 12 of the conductive layer 16 was a linear thin metal film made of silver (Ag), and the thickness (film thickness) L3 was set to 500 nm, a line width L6 was set to 0.5 μm, and the length L7 between adjacent conductors 12 was set to 60 μm. The conductive layer 16 has a surface resistivity of 1.7 Ω/sq. and a conductor coverage ratio of 3.3%.

A rubber-based adhesive was used as the adhesive layer 14. Specifically, the adhesive layer 14 was prepared by charging a reaction vessel equipped with a cooling tube, a nitrogen inlet tube, a thermometer, a dropping funnel, and a stirring device with 100 parts by weight of a rubber-based polymer (a mixture of 50% by mass of a styrene-(ethylene-propylene)-styrene-type block copolymer and 50% by mass of a styrene-(ethylene-propylene)-type block copolymer; styrene content: 15%, weight average molecule amount: 130,000), 40 parts by weight of a synthetic resin (FMR-0150, manufactured by Mitsui Chemicals, Inc.), 20 parts by weight of a softener (LV-100, manufactured by JX Nippon Oil & Energy Corporation), 0.5 parts by weight of an antioxidant (ADK STAB AO-330, manufactured by ADEKA Corporation), and 150 parts by weight of toluene, and then stirring the mixture at 40° C. for 5 hours. The thickness L4 of the adhesive layer 14 was set to 150 μm. The dielectric loss tangent of the adhesive layer 14 is 0.04.

As the protective layer 15, a synthetic resin material sheet (Lumirror 50T60, manufactured by Toray Industries, Inc.) made of PET was used. The thickness L5 of the protective layer 15 was set to 50 μm.

The thickness L1 of the radio wave reflective material 11, the thickness L3 of the conductive layer 16, the thickness L2 of the base material layer 13, the thickness L4 of the adhesive layer 14, and the thickness L5 of the protective layer 15 are determined by measuring any multiple locations and calculating the average of the measurement values obtained. The thicknesses L1 to L5 were measured using a spectroscopic reflectometry film thickness monitor (for example, F3-CS-NIR, manufactured by Filmetrics, Inc.).

The method for producing the radio wave reflective material 11 of Example 1 is explained below. First, the conductor 12 is formed on the base material layer 13. A core layer of 0.01 to 3 μm is formed on one surface of a copper foil having a thickness of 5 to 200 μm, which has sufficient strength as a metal layer, by electrolytic or electroless plating or other methods. Then, the conductive layer 16 in a predetermined arrangement pattern is formed on the surface of the core layer by electrolytic or electroless plating or other methods. Next, the entire surface of the conductive layer 16 is covered with the base material layer 13. The base material layer 13 is coated in advance with an adhesive. Then, the copper foil and the core layer are removed by etching. The conductor 12 is formed on the base material layer 13 in this way.

Then, the protective layer 15 is attached to the side of the conductor 12 opposite to the base material layer 13 using the adhesive layer 14. Using the adhesive layer 14, the protective layer 15 is affixed on the conductor 12 of the base material layer 13 while preventing air bubbles from entering. This produces the radio wave reflective material 11.

The surface resistivity was measured by the four-terminal method in accordance with JIS K 6911 by bringing a measuring terminal into contact with the surface of the conductive layer 16 while the conductive layer 16 was formed and exposed during the production of Example 1 and Comparative Examples 1 and 2.

### Radio Wave Reflection System 100

The radio wave reflection system 100 used for Evaluation Test A is explained. The radio wave reflection system 100 includes a transmitter 20, a receiver 21, and a rotary position adjustment device 50. As illustrated in FIG. 12, a support plate 51 is attached to the rotary position adjustment device 50 (also referred to as “rotary stand 50”), and the radio wave reflectors 10 of Examples 1 to 4 and Comparative Example 1 (hereinafter referred to as “samples”) are attached to this support stand 51. The side edges 11b of the radio wave reflector 10 were fixed to the support plate 51 so that the vertex 11c of the radio wave reflector 10 be positioned at the rotation center of the rotary stand 50 in plan view. The transmitter 20 and the receiver 21 are fixed to a position corresponding to the central position in length of the up-down direction of the radio wave reflector 10. In other words, the transmitter 20, the receiver 21, and vertex 11c located at the center in the up-down direction of the radio wave reflector 10 are aligned in the same plane. This plane is a plane including the incident direction and reflection direction of radio waves. On this plane, the regular reflection angle is set to 60 degrees, the distance between the vertex 11c of the radio wave reflector 10 and the transmitter 20 is set to 4 m, and the distance between the vertex 11c of the radio wave reflector 10 and the receiver 21 is set to 6 m.

A rectangular horn antenna was used as the receiver 21 (receiver antenna), and a spectrum analyzer (MS2760A, manufactured by ANRITSU Corporation) was connected to the receiver 21. An amplifier is interposed between the receiver 21 and the spectrum analyzer. A radio wave at a frequency of 60 GHZ was output from the transmitter 20, and the reception intensity by the receiver 21 was measured. The receiver antenna is not limited to a rectangle horn antenna, and other directional antennas such as dipole antennas or omnidirectional antennas such as omni-antennas may be used.

### Measurement Method of Reception Intensity

The way of measuring the reception intensity (received power) of a sample by the receiver 21 is as follows. In plan view, the radio wave reflector 10 is rotated around the vertex 11c of the radio wave reflector 10. The position of the radio wave reflector 10 when radio waves are regularly reflected was set at a rotation angle φ of 0 degrees, the radio wave reflector 10 was rotated by 1 degree in the range of −90 to +90 degrees, and the reception strength of the receiver 21 was measured at the position of each rotation angle φ. The + direction is a clockwise direction in FIG. 12, and the − direction is a counterclockwise direction in FIG. 12. The radio waves transmitted to a sample have a frequency of 60 GHZ and an output from the transmitter 20 of 1 mW.

### Evaluation Index

As an evaluation index, the reception strength (received power) received by the receiver 21 at each rotation angle φ of the radio wave reflector 10 was measured, and the range of rotation angles φ of the radio wave reflector 10 where the receiver 21 could receive radio waves with an intensity of −95 dB or more, which is practical intensity for use.

### Evaluation Results

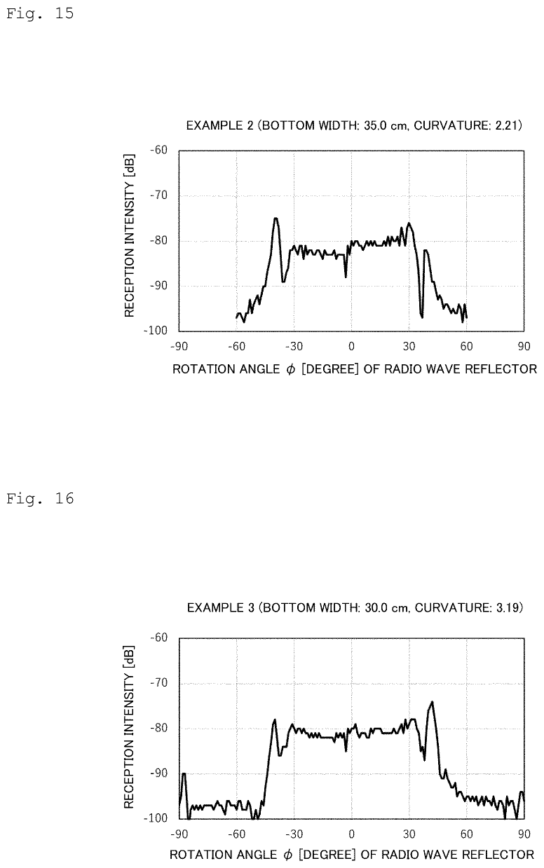

FIGS. 13 to 17 show the measurement results. FIG. 13 shows a result of Comparative Example 1, and the receiver 21 receives radio waves at an intensity of −95 dB or more within the range of rotation angle φ of the radio wave reflector 10 of about −15 degrees to about +15 degrees.

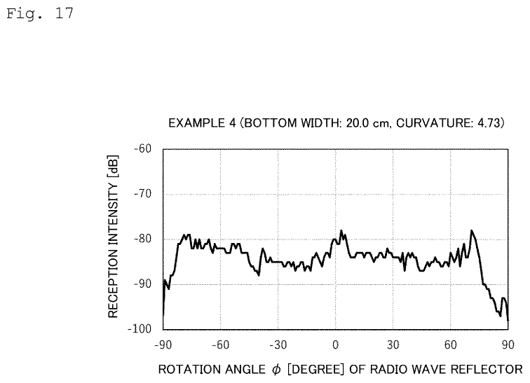

FIG. 14 shows a result of Example 1, and the receiver 21 receives radio waves at an intensity of −95 dB or more within the range of rotation angle φ of the radio wave reflector 10 of about −25 degrees to about +15 degrees. FIG. 15 shows a result of Example 2, and the receiver 21 receives radio waves at an intensity of −95 dB or more within the range of rotation angle φ of the radio wave reflector 10 of about −50 degrees to about +35 degrees. FIG. 16 shows a result of Example 3, and the receiver 21 receives radio waves at an intensity of −95 dB or more within the range of rotation angle φ of the radio wave reflector 10 of about −45 degrees to about +60 degrees. FIG. 17 shows a result of Example 4, and the receiver 21 receives radio waves at an intensity of −95 dB or more within the range of rotation angle φ of the radio wave reflector 10 of about −83 degrees to about +83 degrees.

As such, compared to the flat sheet-shaped radio wave reflector 10 without any protruding shape in Comparative Example 1, the radio wave reflectors 10 having protruding shapes in Examples 1 to 4 had a larger range of rotation angles φ over which the receiver 21 could receive radio waves with sufficient strength that would withstand practical use. Therefore, even if the radio wave reflector 10 was attached to a rotated position within the range of rotation angle φ within a specific range around the vertex 11c, the receiver 21 could receive radio waves with an intensity that would withstand practical use. In Examples 1 to 4, the smaller the bottom width L11, that is, the larger the curvature, the larger the range of rotation angle φ over which the receiver 21 could receive radio waves with sufficient strength that would withstand practical use.

The applicant found that by shaping the reflective surface 11d of the radio wave reflector 10 to be a protruding shape, the radio wave reflector 10 can reflect radio waves with sufficient intensity that would withstand practical use over a wide area of space, compared to the case where the reflective surface 11d of the radio wave reflector 10 is a flat surface. Therefore, even if the radio wave reflector 10 is attached to a rotated position within the range of rotation angle φ within a specific range around the vertex 11c, the receiver 21 can receive radio waves with an intensity that would withstand practical use.

### Evaluation Test B

### Examples 5 to 10

Examples 5 to 10, which were used in Evaluation Test B, are sheet-shaped members having a rectangular planar shape with longitudinal and transverse sizes of 539 mm×485 mm and a thickness L1 of 0.16 mm in a state before being attached to the object 24 to be attached. The values of the bottom widths L11 and the curvatures 1/r are shown as follows.

### (5) Example 5

Bottom width L11 (mm): 482
Curvature 1/r (1/m): 0.792

### (6) Example 6

Bottom width L11 (mm): 462
Curvature 1/r (1/m): 2.23

### (7) Example 7

Bottom width L11 (mm): 438
Curvature 1/r (1/m): 3.24

### (8) Example 8

Bottom width L11 (mm): 385
Curvature 1/r (1/m): 4.75

### (9) Example 9

Bottom width L11 (mm): 365
Curvature 1/r (1/m): 5.25

### (10) Example 10

Bottom width L11 (mm): 243
Curvature 1/r (1/m): 7.81

In Examples 5 to 10, the conductor 12 of the conductive layer 16 was a linear thin metal film made of copper (Cu), and the thickness (film thickness) L3 was set to 1.6 μm, a line width L6 was set to 2.4 μm, and the length L7 between adjacent conductors 12 was set to 100 μm. The conductive layer 16 has a surface resistivity of 0.7 Ω/sq. and a conductor coverage ratio of 7%. Other constitutions are all the same as Example 1, and the explanations therefor are omitted.

Comparative Example 2 is a sheet-shaped member having a rectangular planar shape and longitudinal and transverse sizes of 539 mm×485 mm. Other constitutions are all the same as Comparative Example 1, and the explanations therefor are omitted.

### Radio Wave Reflection System 110

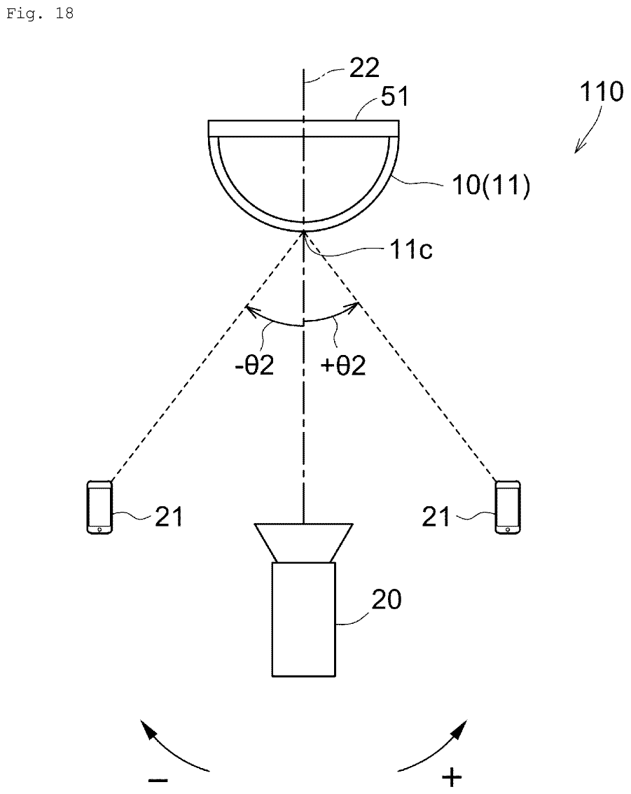

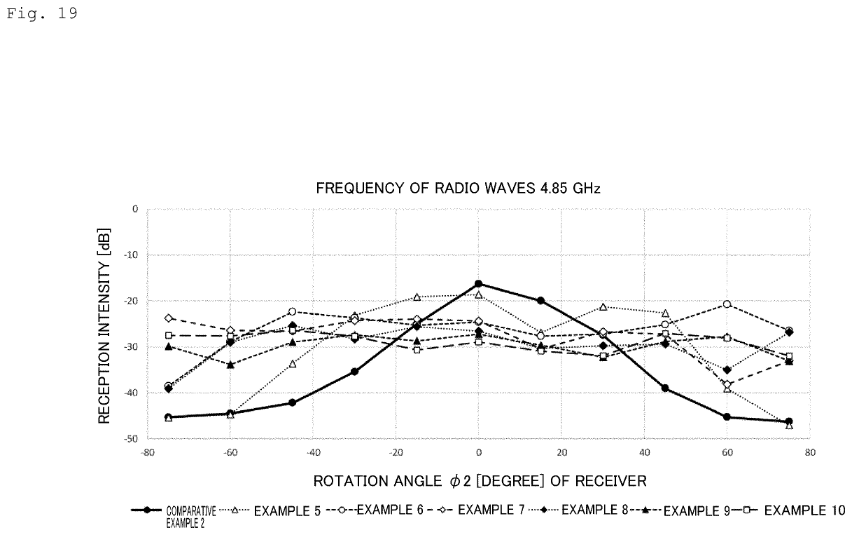

The radio wave reflection system 110 used in Evaluation Test B is explained. As illustrated in FIG. 18, the radio wave reflection system 110 includes a transmitter 20, a receiver 21, and a movement mechanism (not shown) of the receiver 21. The frequency of the radio wave transmitted from the transmitter 20 is 2 GHz or more and 300 GHz or less. The radio wave reflector 10 is installed and fixed so as to protrude toward a side where radio waves are incident or reflected, and the radio wave reflector 10 does not rotate. The transmitter 20 and the receiver 21 are arranged to a position corresponding to the central position in length of the up-down direction of the radio wave reflector 10. In other words, the transmitter 20, the receiver 21, and vertex 11c located at the center in the up-down direction of the radio wave reflector 10 are placed in an identical plane. This plane is a plane including the incident direction and reflection direction of radio waves. On this plane, the transmitter 20 is placed on the normal 22 on the vertex 11c of the radio wave reflector 10. The distance between the vertex 11c and the transmitter 20 is set to 1.0 m. The receiver 21 is movable by the movement mechanism along a hypothetical circle, the radius around the vertex 11c of which is the same in length as the distance between the vertex 11c and the transmitter 20. Other constitutions of the radio wave reflection system 110 are the same as those of the radio wave reflection system 100 used in Evaluation test A.

### Measurement Method of Reception Intensity

The way of measuring the reception intensity (received power) of a sample by the receiver 21 is as follows. The position of the receiver 21 is changed in plan view. In the plane mentioned above, the rotation angle 2 of the receiver 21 when the receiver 21 is located on the normal 22 of the vertex 11c of the radio wave reflector 10 was set to 0 degrees, then the receiver 21 was rotated by 15 degree in the range of −75 to +75 degrees, and the reception intensity of the receiver 21 was measured at the position of each rotation angle φ2. The + direction is a counterclockwise direction in FIG. 18, and the − direction is a clockwise direction in FIG. 18. The radio waves transmitted to the sample have an output from the transmitter 20 of 1 mW.

### Evaluation Index

The rotation angle φ2 of the receiver 21 with respect to Examples 5 to 10 and Comparative Example 2 was changed as above, and reception intensity (received power) received by the receiver 21 was measured. The frequencies of the radio waves transmitted to the sample were set to 4.85 GHZ and 28 GHz.

The evaluation was made as follows. An absolute value of the difference between the reflection intensity at regular reflection (that is, the rotation angle φ2 is 0 degrees) and the reflection intensity at another rotation angle φ2 is determined, and a rotation angle φ2 in which the absolute value of the difference does not exceed 10 dB is extracted. The extracted rotation angle φ2 includes + values to − values. Absolute values of the maximum and the minimum of this extracted rotation angle φ2 value are determined, and a smaller absolute value of the two is selected. The absolute value with a plus sign and the absolute value with a minus sign are determined, and the difference between these values is set as the angular range (unit: degree) of the rotation angle φ2 within which the receiver 21 can receive radio waves with sufficient reception intensity.

For example, in the case of Example 5 indicated in Table 1, −30, −15, +15, +30, and +45 degrees were extracted as the rotation angle in which the absolute value of the difference between the reflection intensity at a rotation angle φ2 of 0 degrees and the reflection intensity at another rotation angle φ2 does not exceed 10 dB. The maximum value of the extracted rotation angle φ2 is 45 and the minimum is −30, the absolute values of which are 45 and 30, respectively. Thus, 30, the smaller one, was selected. Then, the absolute value with + is +30, and the absolute value with minus is −30. The difference therebetween, 60, was set as the angular range of rotation angle φ2 (unit: degree) within which the receiver 21 can receive radio waves with sufficient reception intensity.

A case where the angular range was 150 degrees or more was evaluated as “very good”, a case where the angular range was 120 degrees or more and less than 150 degrees was evaluated as “good”, a case where the angular range was 60 degrees or more and less than 120 degrees was evaluated as “poor”, and a case where the angular range was less than 60 degrees was evaluated as “very poor”. A rating of “very good”, “good”, and “poor” indicates that the radio wave reflector 10 can reflect radio waves over a sufficiently wide angular range and with sufficient strength that would withstand practical use.

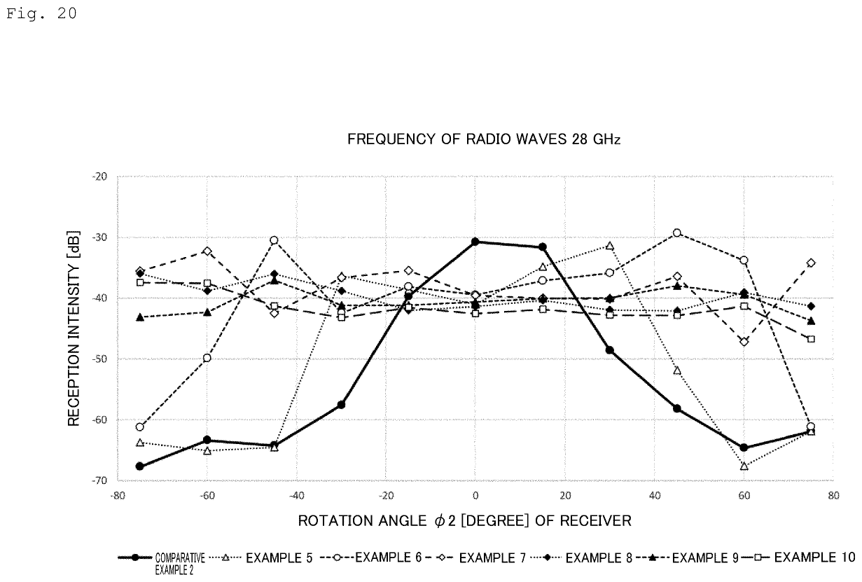

Tables 1 and 2 show the measurement results of reception intensities with respect to the rotation angle φ2 of the receiver 21 and the evaluation of angular ranges. FIGS. 19 and 20 tabulate the measurement results of the reception intensities. In Tables 1 and 2, gray-colored ranges indicate the angular range of the rotation angle φ2 within which the receiver 21 can receive radio waves with sufficient reception intensity. FIG. 19 and Table 1 show the results where the frequency of the radio waves was 4.85 GHz, and FIG. 20 and Table 2 show the results where the frequency of the radio waves was 28 GHz. In Examples 5 to 10, the angular range of rotation angle within which the receiver 21 could receive radio waves with sufficient reception intensity was wider than the case of regular reflection compared with the flat radio wave reflector 10 of Comparative Example 2. As such, even if the receiver 21 was installed in a position deviating from the regular reflection direction of radio waves, the radio wave reflector 10 could reflect radio waves with an intensity that would withstand practical use. The larger the curvature of the radio wave reflector 10, the wider the angular range of rotation angle within which the receiver 21 could receive radio waves with sufficient reception intensity.

TABLE 1
Frequency of radio waves 4.85 GHz

| | | Comparative | | | | | | |
|---|---|---|---|---|---|---|---|---|
| | | Example 1 | Example 5 | Example 6 | Example 7 | Example 8 | Example 9 | Example 10 |
| Curvature (1/m) | | 0 | 0.792 | 2.23 | 3.24 | 4.75 | 5.25 | 7.81 |
| Rotation | 75 | −46.3092 | −47.1134 | −26.4788 | −33.0563 | −26.8761 | −33.1172 | −31.9689 |
| angle | 60 | −45.332 | −39.1273 | −20.8211 | −38.2137 | −35.0501 | −27.7964 | −28.1141 |
| [degree] | 45 | −39.0742 | −22.6609 | −25.1714 | −27.3169 | −29.3941 | −28.8444 | −27.0875 |
| | 30 | −27.5024 | −21.2991 | −27.2376 | −26.7611 | −29.7784 | −32.2971 | −31.9305 |
| | 15 | −20.0185 | −26.9402 | −27.7561 | −30.4416 | −30.308 | −29.6547 | −30.9156 |
| | 0 | −16.3273 | −18.6048 | −24.6256 | −24.3557 | −26.6232 | −27.3202 | −28.9453 |
| | −15 | −25.0423 | −19.1039 | −25.3127 | −23.9271 | −25.6122 | −28.7085 | −30.7126 |
| | −30 | −35.4467 | −23.1402 | −23.7268 | −24.3023 | −28.3417 | −27.4318 | −27.7433 |
| | −45 | −42.2306 | −33.6817 | −22.4055 | −26.6441 | −25.3984 | −28.9413 | −26.4239 |
| | −60 | −44.5613 | −44.7232 | −28.9031 | −26.4356 | −29.0495 | −33.8295 | −27.6761 |
| | −75 | −45.3416 | −45.4175 | −38.5341 | −23.7501 | −39.1448 | −29.9119 | −27.5138 |

| | | | | | | | |
|---|---|---|---|---|---|---|---|
| Evaluation | Very poor | Poor | Good | Poor | Good | Very good | Very good |

TABLE 2
Frequency of radio waves 28 GH

| | | Comparative | | | | | | |
|---|---|---|---|---|---|---|---|---|
| | | Example 1 | Example 5 | Example 6 | Example 7 | Example 8 | Example 9 | Example 10 |
| Curvature (1/m) | | 0 | 0.792 | 2.23 | 3.24 | 4.75 | 5.25 | 7.81 |
| Rotation | 75 | −61.9272 | −61.909 | −61.184 | −34.2199 | −41.344 | −43.7213 | −46.7858 |
| angle | 60 | −64.6609 | −67.6227 | −33.8103 | −47.226 | −39.1056 | −39.4305 | −41.3725 |
| [degree] | 45 | −58.2172 | −51.8745 | −29.3163 | −36.4532 | −42.1132 | −37.9885 | −42.8912 |
| | 30 | −48.6544 | −31.3394 | −35.9194 | −40.1522 | −41.9426 | −39.9814 | −42.8396 |
| | 15 | −31.6655 | −34.8277 | −37.1837 | −40.0707 | −40.3884 | −40.0807 | −41.8547 |
| | 0 | −30.7945 | −41.0514 | −39.4812 | −39.6166 | −41.4185 | −40.6522 | −42.5803 |
| | −15 | −39.726 | −38.6133 | −38.1273 | −35.4985 | −41.999 | −41.1954 | −41.5821 |
| | −30 | −57.6133 | −36.3427 | −42.4819 | −36.6763 | −38.8371 | −41.216 | −43.2371 |
| | −45 | −64.2655 | −64.53983 | −30.5337 | −42.5034 | −36.051 | −37.0753 | −41.2872 |
| | −60 | −63.3919 | −65.1235 | −49.8827 | −32.2992 | −38.8111 | −42.3411 | −37.5821 |
| | −75 | −67.7497 | −63.7488 | −61.2553 | −35.6147 | −36.0114 | −43.1128 | −37.4822 |

| | | | | | | | |
|---|---|---|---|---|---|---|---|
| Evaluation | Very poor | Poor | Poor | Very good | Very good | Very good | Very good |

One embodiment of the present invention has been described above. However, the embodiments of the present disclosure are not limited to the above-described embodiment, and various modifications are possible without departing from the spirit of the present invention. The dimensions, materials, shapes, relative arrangement, or the like of the components described as embodiments or illustrated in the drawings are not intended to limit the scope of the invention thereto, but are merely illustrative examples. For example, the expressions that describe a relative or absolute arrangement, such as “in a certain direction”, “along a certain direction”, “parallel”, “orthogonal”, “center”, “concentric”, or “coaxial”, not only represent such an arrangement strictly, but also a state of relative displacement with tolerances, or angle or distance to the extent that the same function can be achieved. For example, expressions that describe things being in an equal state, such as “the same”, “equal”, and “homogeneous”, shall not only describe a strictly equal state, but also a state in which there are tolerances or differences to the extent that the same functions can be achieved. For example, an expression representing a square, cylindrical, or other shapes shall not only represent a square, cylindrical, or other shape in the strict geometric sense, but shall also represent a shape that includes uneven portions, chamfers, or the like to the extent that the same effect can be achieved. The expressions “comprising”, “including”, “provided with”, “containing”, or “having” one component are not exclusive expressions to exclude the existence of other components.

### DESCRIPTION OF REFERENCE NUMERALS

10 Radio wave reflector
11 Radio wave reflective material
11b Side edge
11c Vertex of protruding shape
12 Conductor
13 Base material layer
14 Adhesive layer
15 Protective layer
16 Conductive layer
20 Transmitter
21 Receiver
24 Object to be attached
40 Holding member
50 Rotary position adjustment device (rotary stand)
100 Radio wave reflection system
101 Radio wave reflection structure
102 Radio wave reflection device
L6 Line width of conductor
L10 Length of one side of radio wave reflector
L11 Bottom width of radio wave reflector
φ, φ2 Rotation angle

1. A radio wave reflector with a reflective surface configured to reflect radio waves,
the reflective surface being a curved surface that protrudes toward a side where the radio waves are incident or reflected.

2. The radio wave reflector according to claim 1, wherein the reflective surface has a curvature 1/r of 0 (1/m)<1/r≤7.85 (1/m).

3. The radio wave reflector according to claim 1, wherein the reflective surface has a curvature 1/r of 5.00 (1/m)<1/r≤7.85 (1/m).

4. The radio wave reflector according to claim 1, comprising a conductive layer that includes a conductor and constitutes the reflective surface, a base material layer that includes a base material for holding the conductive layer, a protective layer that includes a protective material for protecting the conductive layer, and an adhesive layer that includes an adhesive material for adhering the conductive layer and the protective layer, wherein
the base material layer, the conductive layer, the adhesive layer, and the protective layer are laminated in this order.

5. The radio wave reflector according to claim 4, which has a flexural modulus of 0.05 GPa or more and 4 GPa or less.

6. The radio wave reflector according to claim 1, further comprising a holding member configured to hold the reflective surface.

7. A method for producing the radio wave reflector as in claim 1, the method comprising:
a step of curving the reflective surface so that the reflective surface be a curved surface that protrudes toward a side where radio waves are incident or reflected when attached to an object to be attached.

8. A method for producing the radio wave reflector as in claim 6, the method comprising:
a step of holding a curved surface that protrudes toward a side where the radio waves of the reflective surface are incident or reflected by the holding member before being attached to an object to be attached.

9. A radio wave reflection structure comprising:
the radio wave reflector as in claim 1; and
an object to be attached to which the radio wave reflector is attached.

10. A radio wave reflection system comprising:
a transmitter configured to transmit radio waves;
the radio wave reflector as in claim 1 configured to reflect the radio waves transmitted from the transmitter;
a receiver configured to receive the radio waves reflected by the radio wave reflector; and
a rotary position adjustment device installed in the radio wave reflector and configured to rotate the radio wave reflector.

11. The radio wave reflection system according to claim 10, wherein
the rotary position adjustment device rotates the radio wave reflector around a vertex of a protrusion of the radio wave reflector seen from a plane parallel to a surface including an incident direction and a reflection direction to the reflective surface of radio waves;
when a rotation angle in a position of the radio wave reflector in a case where radio waves transmitted from the transmitter are regularly reflected toward the receiver is taken as 0 degrees, a clockwise direction of rotation is taken as + direction, and a counterclockwise direction of rotation is taken as − direction,
a position of the radio wave reflector adjustable by the rotary position adjustment device is within a range of rotation angle of −90 degrees or more and +90 degrees or less.

12. The radio wave reflection system according to claim 11, wherein
the radio wave reflection system has a curvature 1/r of 4.73 (1/m); and
when the radio wave reflector is located in a position within a range of rotation angle of −83 degrees or more and +83 degrees or less,
the receiver receives radio waves of −95 dB or more.

13. A radio wave reflection device comprising:
the radio wave reflector as in claim 1; and
a rotary position adjustment device installed in the radio wave reflector and configured to rotate the radio wave reflector.
